(19) United States
(12) Patent Application Publication
(10) Pub. No.: US 2024/0243772 A1
(43) Pub. Date: Jul. 18, 2024

(54) RADIO FREQUENCY FRONT-END ARCHITECTURE

(71) Applicant: Skyworks Solutions, Inc., Irvine, CA (US)

(72) Inventor: David Richard Pehlke, Westlake Village, CA (US)

(21) Appl. No.: 18/415,475

(22) Filed: Jan. 17, 2024

Related U.S. Application Data
(60) Provisional application No. 63/480,422, filed on Jan. 18, 2023.

(51) Int. Cl. H04B 1/56; H04B 1/44; H04L 5/14

(52) U.S. Cl. CPC H04B 1/56; H04B 1/44; H04L 5/14

(57) ABSTRACT

A radio frequency front end system has a first transmit path and a first receive path. There is a first transmit filter within the first transmit path and a first receive filter within the first receive path. One or more switches can be configured to selectively connect a first antenna to the first transmit filter and to selectively connect a second antenna to the first receive filter to allow frequency division duplex communication over the first transmit path and the first receive path in which the first transmit path transmits over the first antenna simultaneous with the first receive path receiving over the second antenna.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to electronic systems, and in particular, to radio frequency (RF) electronics supporting concurrent reception (Rx) and transmission (Tx) of RF signals.

### Description of the Related Technology

RF communication systems can be used for transmission (Tx) and/or reception (Rx) of RF signals over a wide range of frequencies. For example, a RF communication system can be used to wirelessly communicate RF signals in a frequency range of about 30 kHz to 300 GHz, such as in the range of about 450 MHz to about 7.125 GHz for certain communications standards, e.g., Fifth Generation (5G) cellular communications.

Examples of RF communication systems include, but are not limited to, mobile phones, tablets, base stations, network access points, customer-premises equipment (CPE), laptops, and wearable electronics.

RF communication systems implement dedicated designs for Second Generation (2G), Third Generation (3G), Fourth Generation (4G), Fifth Generation (5G), etc. cellular communications.

### SUMMARY OF CERTAIN INVENTIVE CONCEPTS

Modern RF communication systems support time division duplex (TDD) and frequency division duplex (FDD) operating modes.

The support for FDD operating modes can be challenging because Tx and Rx is concurrent, with Tx and Rx occurring simultaneously. Degradation can occur from Tx carrier signal power and Tx noise in Rx band frequencies leaking over directly onto a Rx path and low noise amplifier (LNA) input. To manage these challenges, e.g., to meet 55 dB to 60 dB Tx-to-Rx isolation specifications, Tx and Rx filters can be brought together into a duplexer where the Tx and Rx filters are co-designed for higher isolation, with a common merged connection and common shared trace for the Tx and Rx to a shared antenna. However, while this can improve isolation, the ganging together of the Tx and Rx filter can adds filter loading and higher insertion losses, presenting a performance challenge for FDD. TDD receive bands can also experience the Tx-to-Rx leakage of the Tx carrier (TxLkg) and Rx band noise (RxBN) from concurrent FDD transmitters, e.g., when TDD Rx is active.

Certain aspects of embodiments disclosed herein address such challenges, e.g., for use in achieving improved power capability and efficiency of dual connectivity (DC) implementations, such as Evolved-Universal Terrestrial Radio Access (E-UTRA) New Radio (NR) dual connectivity (EN-DC) and multi-transmission. Certain embodiments can achieve higher sensitivity, e.g., in terms of maximum sensitivity degradation (MSD), and/or intermodulation distortion (IMD).

In some aspects, the techniques described herein relate to a radio frequency front end system including: a first transmit path and a first receive path; a first transmit filter within the first transmit path and a first receive filter within the first receive path; and one or more switches configured to selectively connect a first antenna to the first transmit filter and to selectively connect a second antenna to the first receive filter to allow frequency division duplex communication over the first transmit path and the first receive path in which the first transmit path transmits over the first antenna simultaneous with the first receive path receiving over the second antenna.

In some aspects, the techniques described herein relate to a radio frequency front end system further including a diversity receive path and a third receive filter within the diversity receive path, the one or more switches further configured to selectively connect a third antenna to the diversity receive path.

In some aspects, the techniques described herein relate to a radio frequency front end system further including a first conductive segment connecting the first transmit filter to a first port of the one or more switches and a second conductive segment connecting the first receive filter to a second port of the one or more switches.

In some aspects, the techniques described herein relate to a radio frequency front end system wherein the one or more switches are further configured to selectively connect the first antenna to both the first transmit filter and first receive filter to allow frequency division duplex communication over the first transmit path and the first receive path in which the first transmit path transmits over the first antenna simultaneous with the first receive path receiving over the first antenna.

In some aspects, the techniques described herein relate to a radio frequency front end system further including a second transmit path and a second receive path, a second transmit filter within the second transmit path and a second receive filter within the second receive path, the one or more switches configured to selectively connect a third antenna to the second transmit filter and to selectively connect a fourth antenna to the second receive filter to allow frequency division duplex communication over the second transmit path and the second receive path in which the second transmit path transmits over the third antenna simultaneous with the second receive path receiving over the fourth antenna.

In some aspects, the techniques described herein relate to a radio frequency front end system wherein the first transmit filter and the first receive filter are in separate integrated circuit packages.

In some aspects, the techniques described herein relate to a radio frequency front end system wherein the first transmit path includes a first transmit power amplifier, the first transmit filter coupled between the first transmit power amplifier and the one or more switches, and the first receive path includes a first receive amplifier, the first receive filter coupled between the one or more switches and the first receive amplifier.

In some aspects, the techniques described herein relate to a radio frequency front end system further including control circuitry configured, in response to one or more commands, cause the one or more switches to selectively connect the first antenna to the first transmit filter and selectively connect the second antenna to the first receive filter.

In some aspects, the techniques described herein relate to a radio frequency front end system wherein the one or more switches include at least a first switch in a first integrated circuit package and at least a second switch in a second integrated circuit package, the first switch configured to selectively connect the first antenna to the first transmit filter and the second switch configured to selectively connect the second antenna to the first receive filter.

In some aspects, the techniques described herein relate to a mobile device including: a first antenna and a second antenna; and a front end system including a first transmit path and a first receive path, a first transmit filter within the first transmit path and a first receive filter within the first receive path, and one or more switches configured to selectively connect the first antenna to the first transmit filter and to selectively connect the second antenna to the first receive filter to allow frequency division duplex communication over the first transmit path and the first receive path in which the first transmit path transmits over the first antenna simultaneous with the first receive path receiving over the second antenna.

In some aspects, the techniques described herein relate to a mobile device wherein the front end system further includes a diversity receive path and a third receive filter within the diversity receive path, the one or more switches further configured to selectively connect a third antenna to the diversity receive path.

In some aspects, the techniques described herein relate to a mobile device further including a first conductive segment connecting the first transmit filter to a first port of the one or more switches and a second conductive segment connecting the first receive filter to a second port of the one or more switches.

In some aspects, the techniques described herein relate to a mobile device wherein the one or more switches are further configured to selectively connect the first antenna to both the first transmit filter and first receive filter to allow frequency division duplex communication over the first transmit path and the first receive path in which the first transmit path transmits over the first antenna simultaneous with the first receive path receiving over the first antenna.

In some aspects, the techniques described herein relate to a mobile device further including a second transmit path and a second receive path, a second transmit filter within the second transmit path and a second receive filter within the second receive path, the one or more switches configured to selectively connect a third antenna to the second transmit filter and to selectively connect a fourth antenna to the second receive filter to allow frequency division duplex communication over the second transmit path and the second receive path in which the second transmit path transmits over the third antenna simultaneous with the second receive path receiving over the fourth antenna.

In some aspects, the techniques described herein relate to a mobile device wherein the first transmit filter and the first receive filter are in separate integrated circuit packages.

In some aspects, the techniques described herein relate to a mobile device wherein the first transmit path includes a first transmit power amplifier, the first transmit filter coupled between the first transmit power amplifier and the one or more switches, and the first receive path includes a first receive amplifier, the first receive filter coupled between the one or more switches and the first receive amplifier.

In some aspects, the techniques described herein relate to a mobile device further including one or more processors, and the front end system further including control circuitry configured, in response to one or more commands issued by the one or more processors, cause the one or more switches to selectively connect the first antenna to the first transmit filter and selectively connect the second antenna to the first receive filter.

In some aspects, the techniques described herein relate to a method of operating a radio frequency system including: actuating one or more switches to selectively connect a first antenna to a first transmit filter, the first transmit filter within a first transmit path; actuating the one or more switches to selectively connect a second antenna to a first receive filter, the first receive filter within a first receive path; and operating the first transmit path and the first receive path to perform frequency division duplex communication over the first transmit path and the first receive path in which the first transmit path transmits over the first antenna simultaneous with the first receive path receiving over the second antenna.

In some aspects, the techniques described herein relate to a method further including: actuating the one or more switches to selectively connect the first antenna to both the first transmit filter and the first receive filter; and operating the first transmit path and the first receive path to perform frequency division duplex communication over the first transmit path and the first receive path in which the first transmit path transmits over the first antenna simultaneous with the first receive path receiving over the first antenna.

In some aspects, the techniques described herein relate to a method further including: actuating the one or more switches to selectively connect a third antenna to a second transmit filter in a second transmit path; actuating the one or more switches to selectively connect a fourth antenna to a second receive filter in a second receive path; performing frequency division duplex communication over the second transmit path and the second receive path in which the second transmit path transmits over the third antenna simultaneous with the second receive path receiving over the fourth antenna.

The systems, methods and devices of this disclosure each have several aspects, no single one of which is solely responsible for the desirable attributes disclosed herein.

In some aspects, the techniques described herein relate to a radio frequency front end system (RFFE) including: a plurality of reception (Rx) and transmission (Tx) paths, each of the plurality of Rx and Tx paths configured for operation in a simplex mode for either reception or transmission.

In some aspects, the techniques described herein relate to a RFFE system wherein the plurality of Rx and Tx paths first Rx path includes a first Rx path and a first Tx path, the first Rx path configured for reception, and the first Tx path configured for transmission.

In some aspects, the techniques described herein relate to a RFFE system wherein the first Rx path includes a first Rx filter and the first Tx path includes a first Tx filter, the first Rx filter and the first Tx filter being separate filters.

In some aspects, the techniques described herein relate to a RFFE system wherein the first Rx path includes a first Rx trace, the first Tx path includes a first Tx trace, and the first Rx trace and the first Tx trace are separate traces.

In some aspects, the techniques described herein relate to a RFFE system wherein the first Rx path includes a first Rx antenna, the first Tx path includes a first Tx antenna, and the first Rx antenna and the first Tx antenna are separate antennas.

In some aspects, the techniques described herein relate to a RFFE system wherein the first Rx path includes a first Rx antenna, the first Tx path includes a first Tx antenna, and the first Rx antenna and the first Tx antenna are separate antennas.

In some aspects, the techniques described herein relate to a RFFE system configured for operation in a time division duplex (TDD) mode of operation.

In some aspects, the techniques described herein relate to a RFFE system configured for operation in a frequency division duplex (FDD) mode of operation.

In some aspects, the techniques described herein relate to a RFFE system wherein two of the plurality of Rx and Tx paths are further configured for operation in a duplex mode for reception and transmission.

In some aspects, the techniques described herein relate to a RFFE system wherein two of the plurality of Rx and Tx paths are further configured for operation in a duplex mode for reception and transmission.

In some aspects, the techniques described herein relate to a RFFE system wherein the two Rx and Tx paths are configured, when operated in the duplex mode, for concurrent reception and transmission.

In some aspects, the techniques described herein relate to a RFFE system wherein the two Rx and Tx paths include, when operated in the duplex mode, a common antenna configured for concurrent reception and transmission.

In some aspects, the techniques described herein relate to a RFFE system further including a switch configured to switchably separate or combine the two Rx and Tx paths for operation in the simplex or the duplex mode of operation.

In some aspects, the techniques described herein relate to a RFFE system configured for operation in a time division duplex (TDD) mode of operation.

In some aspects, the techniques described herein relate to a RFFE system configured for operation in a frequency division duplex (FDD) mode of operation.

In some aspects, the techniques described herein relate to a wireless device including: a transceiver; and a radio frequency front end (RFFE) system, the RFFE system including a plurality of reception (Rx) and transmission (Tx) paths, each of the plurality of Rx and Tx paths configured for operation in a simplex mode for either reception or transmission.

In some aspects, the techniques described herein relate to a wireless device wherein the plurality of Rx and Tx paths first Rx path includes a first Rx path and a first Tx path, the first Rx path configured for reception, and the first Tx path configured for transmission.

In some aspects, the techniques described herein relate to a wireless device wherein the first Rx path includes a first Rx filter and the first Tx path includes a first Tx filter, the first Rx filter and the first Tx filter being separate filters.

In some aspects, the techniques described herein relate to a wireless device wherein the first Rx path includes a first Rx trace, the first Tx path includes a first Tx trace, and the first Rx trace and the first Tx trace are separate traces.

In some aspects, the techniques described herein relate to a wireless device wherein the first Rx path includes a first Rx antenna, the first Tx path includes a first Tx antenna, and the first Rx antenna and the first Tx antenna are separate antennas.

In some aspects, the techniques described herein relate to a wireless device wherein the first Rx path includes a first Rx antenna, the first Tx path includes a first Tx antenna, and the first Rx antenna and the first Tx antenna are separate antennas.

In some aspects, the techniques described herein relate to a wireless device configured for operation in a time division duplex (TDD) mode of operation.

In some aspects, the techniques described herein relate to a wireless device configured for operation in a frequency division duplex (FDD) mode of operation.

In some aspects, the techniques described herein relate to a wireless device wherein two 24 wherein two of the plurality of Rx and Tx paths are further configured for operation in a duplex mode for reception and transmission.

In some aspects, the techniques described herein relate to a wireless device wherein the two Rx and Tx paths are configured, when operated in the duplex mode, for concurrent reception and transmission.

In some aspects, the techniques described herein relate to a wireless device wherein the two Rx and Tx paths include, when operated in the duplex mode, a common antenna configured for concurrent reception and transmission.

In some aspects, the techniques described herein relate to a wireless device further including a switch configured to switchably separate or combine the two Rx and Tx paths for operation in the simplex or the duplex mode of operation.

In some aspects, the techniques described herein relate to a wireless device configured for operation in a time division duplex (TDD) mode of operation.

In some aspects, the techniques described herein relate to a wireless device configured for operation in a frequency division duplex (FDD) mode of operation.

### BRIEF DESCRIPTION OF THE DRAWINGS

FIG. 1 is a diagram of an example dual connectivity network topology.

FIG. 2A is a schematic diagram of one example of a communication link using carrier aggregation.

FIG. 2B illustrates various examples of carrier aggregation for the communication link of FIG. 2A.

FIG. 3A is a schematic diagram of one example of a downlink channel using multi-input and multi-output (MIMO) communications.

FIG. 3B is schematic diagram of one example of an uplink channel using MIMO communications.

FIG. 4A is a schematic diagram of an exemplary radio frequency (RF) system.

FIG. 4B is a schematic diagram of an exemplary RF system.

FIG. 4C is a schematic diagram of an exemplary RF system.

FIG. 5 is a schematic diagram of an exemplary RF system.

FIG. 6 is a schematic diagram of an exemplary RF system.

FIG. 7A is a schematic diagram of an exemplary ultrahigh band (UHB) transmit and receive module.

FIG. 7B is a schematic diagram of an exemplary high band (HB) transmit and receive module.

FIG. 7C is a schematic diagram of an exemplary mid band (MB) transmit and receive module.

FIG. 7D is a schematic diagram of an exemplary 2G power amplifier module (2G PAM).

FIG. 7E is a schematic diagram of an uplink carrier aggregation and MIMO module.

FIG. 8A is a schematic diagram of an example of a front end system including at least one duplex antenna path where transmit and receive share an antenna.

FIG. 8B is a schematic diagram of an example of a front end system with simplex antenna paths on separate antennas.

FIG. 9A is a schematic diagram of an example of another front end system with at least one duplex antenna path where transmit and receive share an antenna.

FIG. 9B is a schematic diagram of a front end system configurable in at least one mode such that each transmit and receive path can operate on a separate antennas.

FIG. 10A is a schematic diagram of an exemplary packaged module.

FIG. 10B is a schematic diagram of a cross-section of the exemplary packaged module of FIG. 10A taken along the line 10B-10B.

FIG. 11 is a schematic diagram of an exemplary mobile device.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The International Telecommunication Union (ITU) is a specialized agency of the United Nations (UN) responsible for global issues concerning information and communication technologies, including the shared global use of radio spectrum.

The 3rd Generation Partnership Project (3GPP) is a collaboration between groups of telecommunications standard bodies across the world, such as the Association of Radio Industries and Businesses (ARIB), the Telecommunications Technology Committee (TTC), the China Communications Standards Association (CCSA), the Alliance for Telecommunications Industry Solutions (ATIS), the Telecommunications Technology Association (TTA), the European Telecommunications Standards Institute (ETSI), and the Telecommunications Standards Development Society, India (TSDSI).

Working within the scope of the ITU, 3GPP develops and maintains technical specifications for a variety of mobile communication technologies, including, for example, second generation (2G) technology (for instance, Global System for Mobile Communications (GSM) and Enhanced Data Rates for GSM Evolution (EDGE)), third generation (3G) technology (for instance, Universal Mobile Telecommunications System (UMTS) and High Speed Packet Access (HSPA)), and fourth generation (4G) technology (for instance, Long Term Evolution (LTE) and LTE-Advanced).

The technical specifications controlled by 3GPP can be expanded and revised by specification releases, which can span multiple years and specify a breadth of new features and evolutions.

In one example, 3GPP introduced carrier aggregation (CA) for LTE in Release 10. Although initially introduced with two downlink carriers, 3GPP expanded carrier aggregation in Release 14 to include up to five downlink carriers and up to three uplink carriers. Other examples of new features and evolutions provided by 3GPP releases include, but are not limited to, License Assisted Access (LAA), enhanced LAA (eLAA), Narrowband Internet of things (NB-IOT), Vehicle-to-Everything (V2X), and High Power User Equipment (HPUE).

3GPP introduced Phase 1 of fifth generation (5G) technology in Release 15, and developed 5G technology further in Release 16. Subsequent 3GPP releases will further evolve and expand 5G technology. 5G technology is also referred to herein as 5G New Radio (NR).

Preliminary specifications for 5G NR support a variety of features, such as communications over millimeter wave spectrum, beam forming capability, high spectral efficiency waveforms, low latency communications, multiple radio numerology, and/or non-orthogonal multiple access (NOMA). Although such RF functionalities offer flexibility to networks and enhance user data rates, supporting such features can pose a number of technical challenges.

The teachings herein are applicable to a wide variety of communication systems, including, but not limited to, communication systems using advanced cellular technologies, such as LTE-Advanced, LTE-Advanced Pro, and/or 5G NR.

### Communication Network

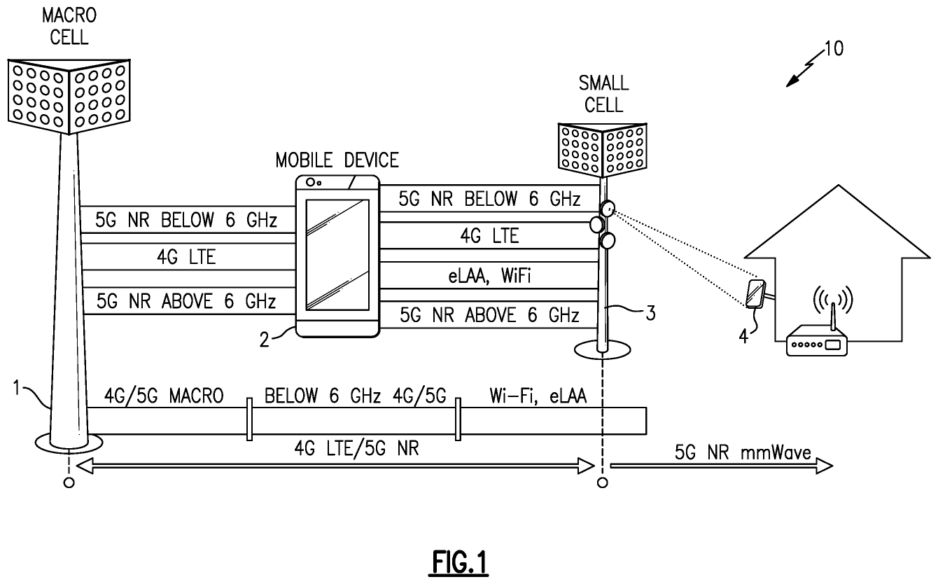

FIG. 1 is a schematic diagram of one example of a communication network 10. The communication network 10 includes a macro cell base station 1, a mobile device 2, a small cell base station 3, and a stationary wireless device 4.

The illustrated communication network 10 of FIG. 1 supports communications using a variety of technologies, including, for example, 4G LTE, 5G NR, and wireless local area network (WLAN), such as Wi-Fi. Although various examples of supported communication technologies are shown, the communication network 10 can be adapted to support a wide variety of communication technologies.

Various communication links of the communication network 10 have been depicted in FIG. 1. The communication links can be duplexed in a wide variety of ways, including, for example, using frequency-division duplexing (FDD) and/or time-division duplexing (TDD). FDD is a type of radio frequency communications that uses different frequencies for transmitting and receiving signals. FDD can provide a number of advantages, such as high data rates and low latency. In contrast, TDD is a type of radio frequency communications that uses about the same frequency for transmitting and receiving signals, and in which transmit and receive communications are switched in time. TDD can provide a number of advantages, such as efficient use of spectrum and variable allocation of throughput between transmit and receive directions.

As shown in FIG. 1, the mobile device 2 communicates with the macro cell base station 1 over a communication link that uses a combination of 4G LTE and 5G NR technologies. The mobile device 2 also communications with the small cell base station 3. In the illustrated example, the mobile device 2 and small cell base station 3 communicate over a communication link that uses 5G NR, 4G LTE, and Wi-Fi technologies. In certain implementations, enhanced license assisted access (eLAA) is used to aggregate one or more licensed frequency carriers (for instance, licensed 4G LTE and/or 5G NR frequencies), with one or more unlicensed carriers (for instance, unlicensed Wi-Fi frequencies).

In certain implementations, the mobile device 2 communicates with the macro cell base station 2 and the small cell base station 3 using 5G NR technology over one or more frequency bands that are less than 6 Gigahertz (GHz) and/or over one or more frequency bands that are greater than 6 GHz. In one embodiment, the mobile device 2 supports a HPUE power class specification.

The illustrated small cell base station 3 also communicates with a stationary wireless device 4. The small cell base station 3 can be used, for example, to provide broadband service using 5G NR technology. In certain implementations, the small cell base station 3 communicates with the stationary wireless device 4 over one or more millimeter wave frequency bands in the frequency range of 30 GHz to 300 GHz and/or upper centimeter wave frequency bands in the frequency range of 24 GHz to 30 GHz.

In certain implementations, the small cell base station 3 communicates with the stationary wireless device 4 using beamforming. For example, beamforming can be used to focus signal strength to overcome path losses, such as high loss associated with communicating over millimeter wave frequencies.

The communication network 10 of FIG. 1 includes the macro cell base station 1 and the small cell base station 3. In certain implementations, the small cell base station 3 can operate with relatively lower power, shorter range, and/or with fewer concurrent users relative to the macro cell base station 1. The small cell base station 3 can also be referred to as a femtocell, a picocell, or a microcell.

Although the communication network 10 is illustrated as including two base stations, the communication network 10 can be implemented to include more or fewer base stations and/or base stations of other types.

The communication network 10 of FIG. 1 is illustrated as including one mobile device and one stationary wireless device. The mobile device 2 and the stationary wireless device 4 illustrate two examples of user devices or user equipment (UE). Although the communication network 10 is illustrated as including two user devices, the communication network 10 can be used to communicate with more or fewer user devices and/or user devices of other types. For example, user devices can include mobile phones, tablets, laptops, IoT devices, wearable electronics, and/or a wide variety of other communications devices.

User devices of the communication network 10 can share available network resources (for instance, available frequency spectrum) in a wide variety of ways.

In one example, frequency division multiple access (FDMA) is used to divide a frequency band into multiple frequency carriers. Additionally, one or more carriers are allocated to a particular user. Examples of FDMA include, but are not limited to, single carrier FDMA (SC-FDMA) and orthogonal FDMA (OFDMA). OFDM is a multicarrier technology that subdivides the available bandwidth into multiple mutually orthogonal narrowband subcarriers, which can be separately assigned to different users.

Other examples of shared access include, but are not limited to, time division multiple access (TDMA) in which a user is allocated particular time slots for using a frequency resource, code division multiple access (CDMA) in which a frequency resource is shared amongst different users by assigning each user device a unique code, space-divisional multiple access (SDMA) in which beamforming is used to provide shared access by spatial division, and non-orthogonal multiple access (NOMA) in which the power domain is used for multiple access. For example, NOMA can be used to serve multiple user devices at the same frequency, time, and/or code, but with different power levels.

Enhanced mobile broadband (eMBB) refers to technology for growing system capacity of LTE networks. For example, eMBB can refer to communications with a peak data rate of at least 10 Gbps and a minimum of 100 Mbps for each user device. Ultra-reliable low latency communications (uRLLC) refers to technology for communication with very low latency, for instance, less than 2 milliseconds. uRLLC can be used for mission-critical communications such as for autonomous driving and/or remote surgery applications. Massive machine-type communications (mMTC) refers to low cost and low data rate communications associated with wireless connections to everyday objects, such as those associated with Internet of Things (IoT) applications.

The communication network 10 of FIG. 1 can be used to support a wide variety of advanced communication features, including, but not limited to eMBB, uRLLC, and/or mMTC.

A peak data rate of a communication link (for instance, between a base station and a user device) depends on a variety of factors. For example, peak data rate can be affected by channel bandwidth, modulation order, a number of component carriers, and/or a number of antennas used for communications.

For instance, in certain implementations, a data rate of a communication link can be about equal to M*B*log2(1+S/N), where M is the number of communication channels, B is the channel bandwidth, and S/N is the signal-to-noise ratio (SNR).

Accordingly, data rate of a communication link can be increased by increasing the number of communication channels (for instance, transmitting and receiving using multiple antennas), using wider bandwidth (for instance, by aggregating carriers), and/or improving SNR (for instance, by increasing transmit power and/or improving receiver sensitivity).

5G NR communication systems can employ a wide variety of techniques for enhancing data rate and/or communication performance.

### Carrier Aggregation

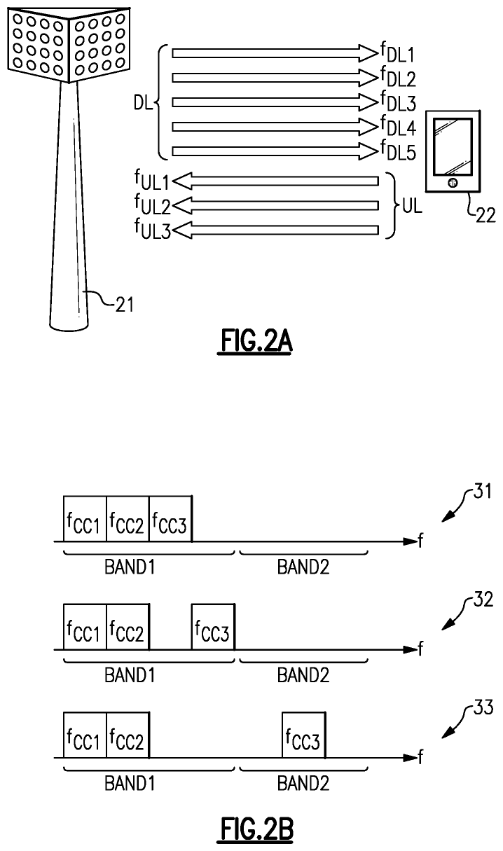

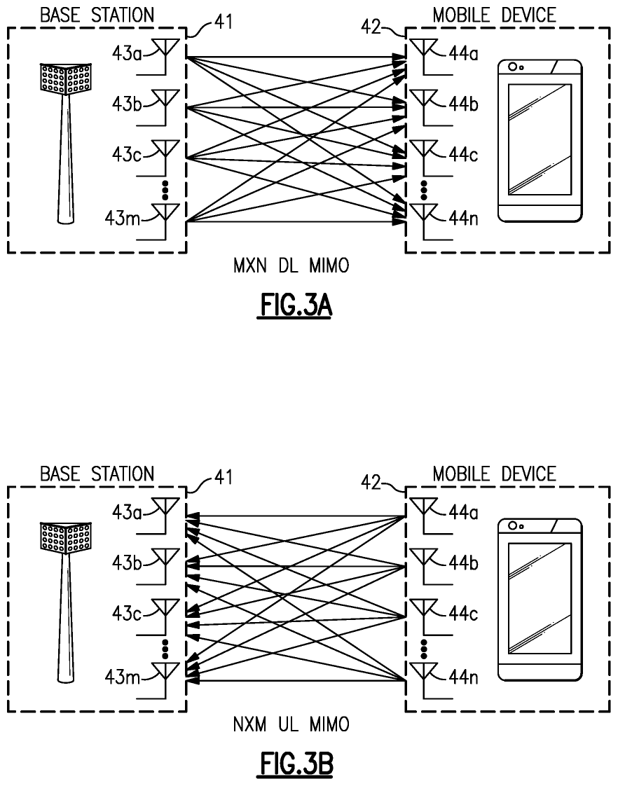

FIG. 2A is a schematic diagram of one example of a communication link using carrier aggregation. Carrier aggregation can be used to widen bandwidth of the communication link by supporting communications over multiple frequency carriers, thereby increasing user data rates and enhancing network capacity by utilizing fragmented spectrum allocations.

In the illustrated example, the communication link is provided between a base station 21 and a mobile device 22. As shown in FIG. 2A, the communications link includes a downlink channel used for RF communications from the base station 21 to the mobile device 22, and an uplink channel used for RF communications from the mobile device 22 to the base station 21.

Although FIG. 2A illustrates carrier aggregation in the context of FDD communications, carrier aggregation can also be used for TDD communications.

In certain implementations, a communication link can provide asymmetrical data rates for a downlink channel and an uplink channel. For example, a communication link can be used to support a relatively high downlink data rate to enable high speed streaming of multimedia content to a mobile device, while providing a relatively slower data rate for uploading data from the mobile device to the cloud.

In the illustrated example, the base station 21 and the mobile device 22 communicate via carrier aggregation, which can be used to selectively increase bandwidth of the communication link. Carrier aggregation includes contiguous aggregation, in which contiguous carriers within the same operating frequency band are aggregated. Carrier aggregation can also be non-contiguous, and can include carriers separated in frequency within a common band or in different bands.

In the example shown in FIG. 2A, the uplink channel includes three aggregated component carriers fUL1, fUL2, and fUL3. Additionally, the downlink channel includes five aggregated component carriers fDL1, fDL2, fDL3, fDL4, and fDL5. Although one example of component carrier aggregation is shown, more or fewer carriers can be aggregated for uplink and/or downlink. Moreover, a number of aggregated carriers can be varied over time to achieve desired uplink and downlink data rates.

For example, a number of aggregated carriers for uplink and/or downlink communications with respect to a particular mobile device can change over time. For example, the number of aggregated carriers can change as the device moves through the communication network and/or as network usage changes over time.

FIG. 2B illustrates various examples of carrier aggregation for the communication link of FIG. 2A. FIG. 2B includes a first carrier aggregation scenario 31, a second carrier aggregation scenario 32, and a third carrier aggregation scenario 33, which schematically depict three types of carrier aggregation.

The carrier aggregation scenarios 31-33 illustrate different spectrum allocations for a first component carrier fcc1, a second component carrier fcc2, and a third component carrier fcc3. Although FIG. 2B is illustrated in the context of aggregating three component carriers, carrier aggregation can be used to aggregate more or fewer carriers.

The first carrier aggregation scenario 31 illustrates intra-band contiguous carrier aggregation, in which component carriers that are adjacent in frequency and in a common frequency band are aggregated. For example, the first carrier aggregation scenario 31 depicts aggregation of component carriers fcc1, fcc2, and fcc3 that are contiguous and located within a first frequency band BAND1.

With continuing reference to FIG. 2B, the second carrier aggregation scenario 32 illustrates intra-band non-continuous carrier aggregation, in which two or more components carriers that are non-adjacent in frequency and within a common frequency band are aggregated. For example, the second carrier aggregation scenario 32 depicts aggregation of component carriers fcc1, fcc2, and fcc3 that are non-contiguous, but located within a first frequency band BAND1.

The third carrier aggregation scenario 33 illustrates inter-band non-contiguous carrier aggregation, in which component carriers that are non-adjacent in frequency and in multiple frequency bands are aggregated. For example, the third carrier aggregation scenario 33 depicts aggregation of component carriers fcc1 and fcc2 of a first frequency band BAND1 with component carrier fcc3 of a second frequency band BAND2.

With reference to FIGS. 2A and 2B, the individual component carriers used in carrier aggregation can be of a variety of frequencies, including, for example, frequency carriers in the same band or in multiple bands. Additionally, carrier aggregation is applicable to implementations in which the individual component carriers are of about the same bandwidth as well as to implementations in which the individual component carriers have different bandwidths.

Certain communication networks allocate a particular user device with a primary component carrier (PCC) or anchor carrier for uplink and a PCC for downlink. Additionally, when the mobile device communicates using a single frequency carrier for uplink or downlink, the user device communicates using the PCC. To enhance bandwidth for uplink communications, the uplink PCC can be aggregated with one or more uplink secondary component carriers (SCCs). Additionally, to enhance bandwidth for downlink communications, the downlink PCC can be aggregated with one or more downlink SCCs.

In certain implementations, a communication network provides a network cell for each component carrier. Additionally, a primary cell can operate using a PCC, while a secondary cell can operate using a SCC. The primary and second cells may have different coverage areas, for instance, due to differences in frequencies of carriers and/or network environment.

License assisted access (LAA) refers to downlink carrier aggregation in which a licensed frequency carrier associated with a mobile operator is aggregated with a frequency carrier in unlicensed spectrum, such as Wi-Fi. LAA employs a downlink PCC in the licensed spectrum that carries control and signaling information associated with the communication link, while unlicensed spectrum is aggregated for wider downlink bandwidth when available. LAA can operate with dynamic adjustment of secondary carriers to avoid Wi-Fi users and/or to coexist with Wi-Fi users. Enhanced license assisted access (eLAA) refers to an evolution of LAA that aggregates licensed and unlicensed spectrum for both downlink and uplink.

### Multi-Input and Multi-Output (MIMO) Communications

FIG. 3A is a schematic diagram of one example of a downlink channel using multi-input and multi-output (MIMO) communications. FIG. 3B is schematic diagram of one example of an uplink channel using MIMO communications.

MIMO communications use multiple antennas for simultaneously communicating multiple data streams over common frequency spectrum. In certain implementations, the data streams operate with different reference signals to enhance data reception at the receiver. MIMO communications benefit from higher SNR, improved coding, and/or reduced signal interference due to spatial multiplexing differences of the radio environment.

MIMO order refers to a number of separate data streams sent or received. For instance, MIMO order for downlink communications can be described by a number of transmit antennas of a base station and a number of receive antennas for UE, such as a mobile device. For example, two-by-two (2×2) DL MIMO refers to MIMO downlink communications using two base station antennas and two UE antennas. Additionally, four-by-four (4×4) DL MIMO refers to MIMO downlink communications using four base station antennas and four UE antennas.

In the example shown in FIG. 3A, downlink MIMO communications are provided by transmitting using M antennas 43a, 43b, 43c, . . . 43m of the base station 41 and receiving using N antennas 44a, 44b, 44c, . . . 44n of the mobile device 42. Accordingly, FIG. 3A illustrates an example of M×N DL MIMO.

Likewise, MIMO order for uplink communications can be described by a number of transmit antennas of UE, such as a mobile device, and a number of receive antennas of a base station. For example, 2×2 UL MIMO refers to MIMO uplink communications using two UE antennas and two base station antennas. Additionally, 4×4 UL MIMO refers to MIMO uplink communications using four UE antennas and four base station antennas.

In the example shown in FIG. 3B, uplink MIMO communications are provided by transmitting using N antennas 44a, 44b, 44c, . . . 44n of the mobile device 42 and receiving using M antennas 43a, 43b, 43c, . . . 43m of the base station 41. Accordingly, FIG. 3B illustrates an example of N×M UL MIMO.

By increasing the level or order of MIMO, bandwidth of an uplink channel and/or a downlink channel can be increased.

MIMO communications are applicable to dual connectivity and to communication links of a variety of types, such as FDD communication links and TDD communication links.

### Examples of Radio Frequency Electronics

A radio frequency (RF) communication device can include multiple antennas for supporting wireless communications. Additionally, the RF communication device can include a radio frequency front-end (RFFE) system for processing signals received from and transmitted by the antennas. The RFFE system can provide a number of functions, including, but not limited to, signal filtering, controlling component connectivity to the antennas, and/or signal amplification.

RFFE systems can be used to handle RF signals of a wide variety of types, including, but not limited to, wireless local area network (WLAN) signals, Bluetooth signals, and/or cellular signals.

Additionally, RFFE systems can be used to process signals of a wide range of frequencies. For example, certain RFFE systems can operate using one or more low bands (for example, RF signal bands having a frequency content of 1 GHz or less, also referred to herein as LB), one or more mid bands (for example, RF signal bands having a frequency content between 1 GHz and 2.3 GHz, also referred to herein as MB), one or more high bands (for example, RF signal bands having a frequency content between 2.3 GHz and 3 GHz, also referred to herein as HB), and one or more ultrahigh bands (for example, RF signal bands having a frequency content between 3 GHz and 6 GHz, also referred to herein as UHB).

RFFE systems can be used in a wide variety of RF communication devices, including, but not limited to, smartphones, base stations, laptops, handsets, wearable electronics, and/or tablets.

An RFFE system can be implemented to support a variety of features that enhance bandwidth and/or other performance characteristics of the RF communication device in which the RFFE system is incorporated.

In one example, an RFFE system is implemented to support carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels, for instance up to five carriers. Carrier aggregation includes contiguous aggregation, in which contiguous carriers within the same operating frequency band are aggregated. Carrier aggregation can also be non-contiguous, and can include carriers separated in frequency within a common band or in different bands.

In another example, a RFFE system is implemented to support multi-input and multi-output (MIMO) communications to increase throughput and enhance mobile broadband service. MIMO communications use multiple antennas for communicating multiple data streams over a single radio frequency channel. MIMO communications benefit from higher signal to noise ratio, improved coding, and/or reduced signal interference due to spatial multiplexing differences of the radio environment.

MIMO order refers to a number of separate data streams sent or received. For instance, a MIMO order for downlink communications can be described by a number of transmit antennas of a base station and a number of receive antennas for user equipment (UE), such as a mobile device.

RFFE systems that support carrier aggregation and multi-order MIMO can be used in RF communication devices that operate with wide bandwidth. For example, such RFFE systems can be used in applications servicing multimedia content streaming at high data rates.

Fifth Generation (5G) technology seeks to achieve high peak data rates above 10 Gbps. Certain 5G high-speed communications can be referred to herein as Enhanced Multi-user Broadband (eMBB).

To achieve eMBB data rates, RF spectrum available at millimeter wave frequencies (for instance, 30 GHz and higher) is attractive, but significant technical hurdles are present in managing the loss, signal conditioning, radiative phased array aspects of performance, beam tracking, test, and/or packaging in the handset associated with millimeter wave communications.

The RFFE systems herein can operate using not only LB, MB, and HB frequencies, but also ultrahigh band (UHB) frequencies in the range of about 3 GHz to about 6 GHz, and more particular between about 3.4 GHz and about 3.8 GHz. By communicating using UHB, enhanced peak data rates can be achieved without the technical hurdles associated with millimeter wave communications.

In certain implementations herein, UHB transmit and receive modules are employed for both transmission and reception of UHB signals via at least two primary antennas and at least two diversity antennas, thereby providing both 4×4 RX MIMO and 4×4 TX MIMO with respect to one or more UHB frequency bands, such as Band 42 (about 3.4 GHz to about 3.6 GHz), Band 43 (about 3.6 GHz to about 3.8 GHz), and/or Band 48 (about 3.55 GHz to about 3.7 GHz). Furthermore, in certain configurations, the RFFE systems herein employ carrier aggregation using one or more UHB carrier frequencies, thereby providing flexibility to widen bandwidth for uplink and/or downlink communications.

By enabling high-order MIMO and/or carrier aggregation features using UHB spectrum, enhanced data rates can be achieved. Additionally, rather than using dedicated 5G antennas and a separate transceiver, shared antennas and/or a shared transceiver (for example, a semiconductor die including a shared transceiver fabricated thereon) can be used for both 5G UHB communications and 4G/LTE communications associated with HB, MB, and/or LB. Thus, 4G/LTE communications systems can be extended to support sub-6 GHz 5G capabilities with a relatively small impact to system size and/or cost.

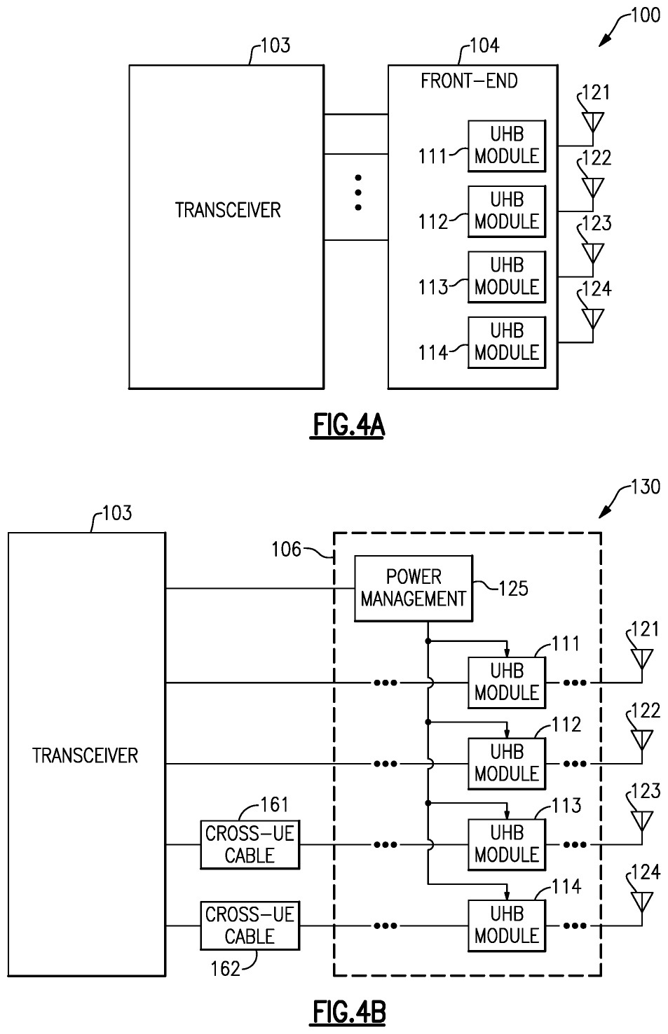

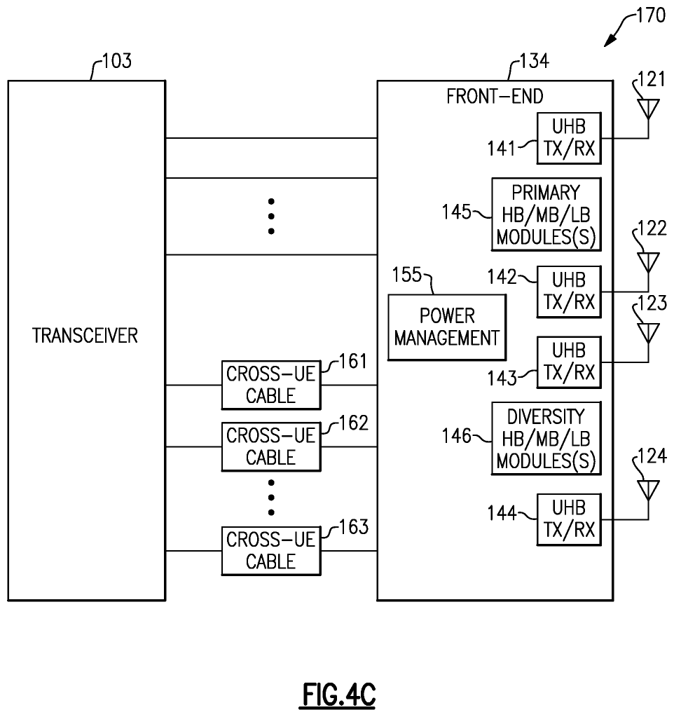

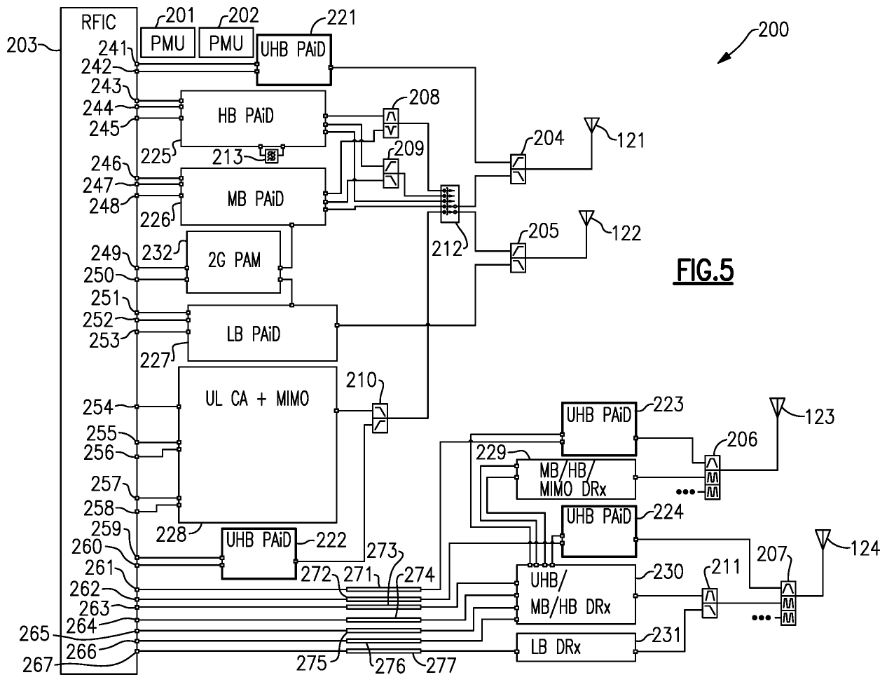

FIG. 4A is a schematic diagram of an RF system 100. The RF system 100 includes a radio frequency integrated circuit (RFIC) or transceiver 103, a front-end system 104 and antennas 121-124. In certain implementations, the antenna 121 is a first primary antenna, the antenna 122 is a second primary antenna, the antenna 123 is a first diversity antenna, and the antenna 124 is a second diversity antenna.

Although the RF system 100 is depicted as including certain components, other implementations are possible, including, but not limited to, implementations using other numbers of antennas, different implementations of components, and/or additional components.

The front-end system 104 includes a first UHB module 111, a second UHB module 112, a third UHB module 113, and a fourth UHB module 114. The front-end system 104 further includes separate antenna terminals for coupling to each of the antennas 121-124.

Thus, the front-end system 104 of FIG. 4A includes multiple UHB modules for supporting communications of UHB signals across multiple antennas. For example, in certain implementations, the UHB modules 111-114 are configured to transmit and receive UHB signals via the antennas 121-124, respectively. Accordingly, broadband communications via UHB frequency carriers can be achieved.

For clarity of the figures, the front end system 104 is depicted as including only the UHB modules 111-114. However, the front end system 104 typically includes additionally components and circuits, for example, modules associated with LB, MB, and/or HB cellular communications. Furthermore, modules can be included for Wi-Fi, Bluetooth, and/or other non-cellular communications.

FIG. 4B is a schematic diagram of an RF system 130. The RF system 130 includes a transceiver 103, a front-end system 106, a first primary antenna 121, a second primary antenna 122, a first diversity antenna 123, a second diversity antenna 124, a first cross-UE cable 161, and a second cross-UE cable 162. As shown in FIG. 4B, the front-end system 106 includes a first UHB module 111, a second UHB module 112, a third UHB module 113, a fourth UHB module 114, and a power management circuit 125. The front-end system 106 further includes a first primary antenna terminal for coupling to the first primary antenna 121, a second primary antenna terminal for coupling to the second primary antenna 122, a first diversity antenna terminal for coupling to the first diversity antenna 123, and a second diversity antenna terminal for coupling to the second diversity antenna 124.

As shown in FIG. 4B, the first UHB module 111 and the second UHB module 112 communicate using the first primary antenna 121 and the second primary antenna 122, respectively, and are connected to the transceiver 103 without the use of cross-UE cables.

Additionally, the third UHB module 113 and the fourth UHB module 114 communicate using the first diversity antenna 123 and the second diversity antenna 124, respectively, and are connected to the transceiver 103 using the first cross-UE cable 161 and the second cross-UE cable 162, respectively.

To reduce the statistical correlation between received signals, the primary antennas 121-122 and the diversity antennas 123-124 can be separated by a relatively large physical distance in the RF system 130. For example, the diversity antennas 123-124 can be positioned near the top of the device and the primary antennas 121-122 can be positioned near the bottom of the device, or vice-versa. Additionally, the transceiver 103 can be positioned near the primary antennas 121-122 and primary modules to enhance performance of primary communications.

Accordingly, in certain implementations, the UHB modules 113-114 and diversity antennas 123-124 can be located at relatively far physical distance from the transceiver 103 and connected to the transceiver 103 via cross-UE cables 161-162, respectively.

In the illustrated example, the front-end system 106 further includes a shared power management circuit 125 used to provide a supply voltage, such as a power amplifier supply voltage, to the UHB modules 111-114.

Providing power to the UHB modules 111-114 using the shared power management circuit 125 can provide a number of advantages, including, for example, high integration, reduced component count, and/or lower cost.

In certain implementations, the shared power management circuit 125 operates using average power tracking (APT), in which the voltage level of the supply voltage provided by the shared power management circuit 125 is substantially fixed over a given communication time slot. In certain implementations, the supply voltage has a relatively high voltage, and thus operates with a corresponding low current. Thus, although the UHB modules 111-114 can be distributed across the device over relatively wide distances and connected using resistive cables and/or conductors, power or I<2>*R losses can be relatively small.

Accordingly, the shared power management circuit 125 can provide high integration with relatively low power loss.

FIG. 4C is a schematic diagram of an RF system 170 according to another example. The RF system 170 includes a transceiver 103, a front-end system 134, a first primary antenna 121, a second primary antenna 122, a first diversity antenna 123, a second diversity antenna 124, a first cross-UE cable 161, a second cross-UE cable 162, and a third cross-UE cable 163.

The illustrated RF system 170 is used to transmit and receive signals of a wide variety of frequency bands, including LB, MB, HB, and UHB cellular signals. For example, the RF system 170 can process one or more LB signals having a frequency content of 1 GHz or less, one or more MB signals having a frequency content between 1 GHz and 2.3 GHz, one or more HB signals having a frequency content between 2.3 GHz and 3 GHz, and one or more UHB signals have a frequency content between 3 GHz and 6 GHz. Examples of LB frequencies include, but are not limited to Band 8, Band 20, and Band 26. Examples of MB frequencies include, but are not limited to, Band 1, Band 3, Band 4, and Band 66. Examples of HB frequencies include, but are not limited to, Band 7, Band 38, and Band 41. Examples of UHB frequencies include, but are not limited to, Band 42, Band 43, and Band 48.

The illustrated front-end system 134 includes one or more primary modules 145 used for transmitting and receive HB, MB, and/or LB signals via the primary antennas 121-122. Although illustrated as a single block, the primary modules 145 can include multiple modules collectively used to transmit and receive HB, MB, and/or LB signals via the first primary antenna 121 and the second primary antenna 122. Additionally, in certain implementations, the first primary antenna 121 and the second primary antenna 122 can be used for communicating over certain frequency ranges. For instance, in one example, the second primary antenna 122 supports LB communications but the first primary antenna 121 does not support LB communications.

With continuing reference to FIG. 4C, the front-end system 134 further includes one or more diversity modules 146 used for receiving HB, MB, and/or LB diversity signals via the diversity antennas 123-124. In certain implementations, the diversity modules 146 operate to receive but not transmit diversity signals. In other implementations, the diversity modules 146 also can be used for transmitting HB, MB, and/or LB signals.

In the illustrated example, the front-end system 134 further includes a first UHB transmit and receive (TX/RX) module 141 electrically coupled to the first primary antenna 121, a second UHB transmit and receive module 142 electrically coupled to the second primary antenna 122, a third UHB transmit and receive module 143 electrically coupled to the first diversity antenna 123, and a fourth UHB transmit and receive module 144 electrically coupled to the second diversity antenna 124. The front-end system 134 further includes a first primary antenna terminal for coupling to the first primary antenna 121, a second primary antenna terminal for coupling to the second primary antenna 122, a first diversity antenna terminal for coupling to the first diversity antenna 123, and a second diversity antenna terminal for coupling to the second diversity antenna 124.

In the illustrated example, the UHB transmit and receive modules 141-144 support transmit and receive of one or more UHB frequency bands, including, but not limited to, Band 42, Band 43, and/or Band 48.

Accordingly, the UHB transmit and receive modules 141-144 can be used to support 4×4 RX MIMO for UHB, 4×4 TX MIMO for UHB, and/or carrier aggregation using one or more UHB frequency carriers. Carrier aggregation using UHB frequency spectrum can include not only carrier aggregation using two or more UHB frequency carriers, but also carrier aggregation using one or more UHB frequency carriers and one or more non-HB frequency carriers, such as HB and/or MB frequency carriers.

In certain communications networks, a user demand for high downlink data rates can exceed a demand for high uplink data rates. For instance, UEs of the network, such as smartphones, may desire high speed downloading of multimedia content, but uploading relatively little data to the cloud. This in turn, can lead to the network operating with a relatively low UL to DL time slot ratio and limited opportunities for UL communications.

However, DL data rate of a network can be limited or bottlenecked by an UL data rate. For instance, in certain networks, UL data rate must stay within about 5% of DL data rate to support control, acknowledgement, and other overhead associated with the communication link. Accordingly, higher DL data rates can be achieved by increasing UL data rate.

The front-end system 134 of FIG. 4C includes UHB transmit and receive modules that advantageously support both transmission and reception of UHB signals. Accordingly, broadband UL communications via UHB frequency carriers can be achieved, thereby enhancing UL data rate and providing sufficient UL bandwidth to support overhead associated with very high data rate DL communications.

The illustrated RF system 170 advantageously includes four transmit capable UHB transmit and receive modules 141-144 coupled to the antennas 121-124, respectively. Thus, both transmit and receive are equally available at each of the antennas 121-124 for UHB communications. Thus, antenna swap can be accomplished without a swap switch to redirect a trace or route. For example, antenna selection can be achieved by controlling whether or not each UHB transmit and receive module is transmitting or receiving. Accordingly, the RF system 170 achieves antenna swap functionality for UHB without using any antenna swap switch.

In the illustrated example, a shared or common transceiver 103 is used for both 4G/LTE communications using HB, MB, and LB frequencies, and also for UHB communications supporting sub-6 GHz 5G. Thus, rather than using a separate or dedicated 5G front-end and antenna interface, the shared transceiver 103 is used for both 4G/LTE communications via HB, MB, and LB frequencies and 5G UHB communications.

The illustrated RF system 170 also employs diversity communications to enhance performance. To reduce the correlation between received signals, the primary antennas 121-122 and the diversity antennas 123-124 can be separated by a relatively large physical distance in the RF system 170. For example, the diversity antennas 123-124 can be positioned near the top of the device and the primary antennas 121-122 can be positioned near the bottom of the device or vice-versa. Additionally, the transceiver 103 can be positioned near the primary antennas 121-122 and primary modules to enhance performance of primary communications.

Accordingly, in certain implementations, the UHB transmit and receive modules 143-144, the diversity module(s) 146, and the diversity antennas 123-124 can be located at relatively far physical distance from the transceiver 103 and connected to the transceiver 103 via cross-UE cables 161-163. Additionally, the UHB transmit and receive modules 141-144 can be distributed and/or placed in remote locations around the RF system 170. Although three cross-UE cables are illustrated, more or fewer cross-UE cables can be included as indicated by the ellipsis.

In the illustrated example, the front-end system 134 further includes a power management circuit 155. In certain implementations, the power management circuit 155 is used to provide a supply voltage, such as a power amplifier supply voltage, which is shared by multiple components including the UHB transmit and receive modules 141-144.

Providing power to the UHB transmit and receive modules 141-144 using a shared power management circuit can provide a number of advantages, including, for example, high integration, reduced component count, and/or lower cost.

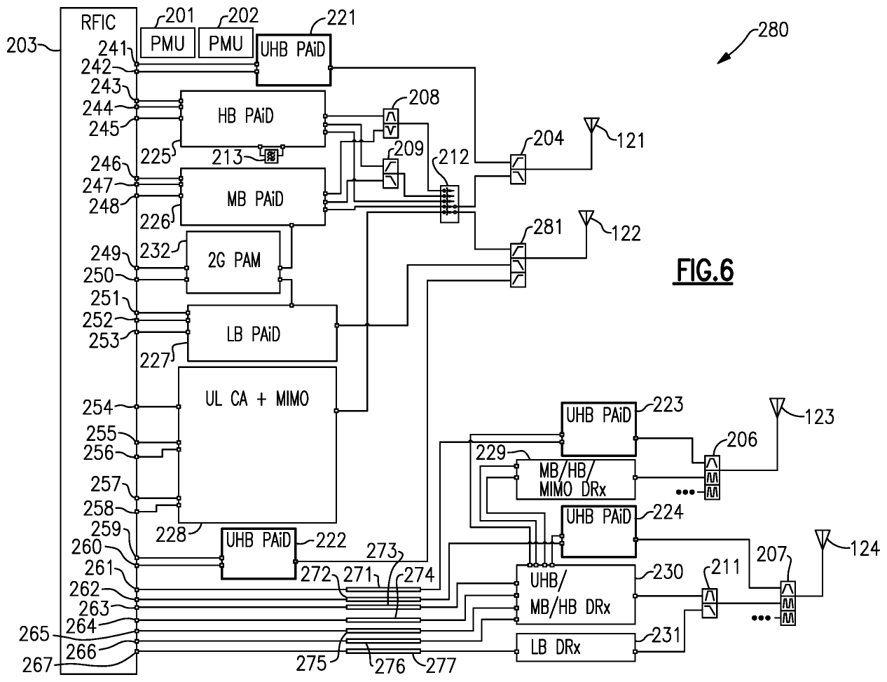

FIG. 5 is a schematic diagram of an RF system 200. The RF system 200 includes a first primary antenna 121, a second primary antenna 122, a first diversity antenna 123, a second diversity antenna 124, a first power management unit (PMU) 201, a second PMU 202, a transceiver or RFIC 203, a first primary antenna diplexer 204, a second primary antenna diplexer 205, a first diversity antenna triplexer 206, a second diversity antenna triplexer 207, a first HB/MB diplexer 208, a second HB/MB diplexer 209, a MIMO/UHB diplexer 210, a diversity diplexer 211, a multi-throw switch 212, an HB TDD filter 213, a first UHB power amplifier with integrated duplexer (PAiD) module 221, a second UHB PAiD module 222, a third UHB PAiD module 223, a fourth UHB PAiD module 224, a HB PAiD module 225, an MB PAiD module 226, an LB PAiD module 227, a UL CA and MIMO module 228, an MB/HB MIMO diversity receive (DRx) module 229, a UHB/MB/HB DRx module 230, an LB DRx module 231, a 2G power amplifier module (PAM) 232, a first cross-UE cable 271, a second cross-UE cable 272, a third cross-UE cable 273, a fourth cross-UE cable 274, a fifth cross-UE cable 275, a sixth cross-UE cable 276, and a seventh cross-UE cable 277.

The RF system 200 includes a RFFE that provides full sub-6 GHz 5G capability provided by four remote placements of UHB PAiD modules 221-224. Although one specific example of a RF system with UHB modules is shown, the teachings herein are applicable to RF electronics implemented in a wide variety of ways. Accordingly, other implementations are possible.

As shown in FIG. 5, the first UHB PAiD module 221 is coupled to the first primary antenna 121, and the second UHB PAiD module 222 is coupled to the second primary antenna 122. Additionally, the third UHB PAiD module 223 is coupled to the first diversity antenna 123, and the fourth UHB PAiD module 224 is coupled to the second diversity antenna 124. Accordingly, one UHB PAiD module is included for each of the four antennas of this example.

In certain implementations, the UHB PAiD modules 221-224 support transmit and receive of one or more UHB frequency bands, including, but not limited to, Band 42, Band 43, and/or Band 48.

The RF system 200 of FIG. 5 supports 4×4 RX MIMO for UHB, 4×4 TX MIMO for UHB, and carrier aggregation (CA) with 4G and/or 5G bands.

As will be described below, the first PMU 201 and the second PMU 202 are used to provide power management to certain modules. For clarity of the figures, a connection from each PMU to the modules it powers is omitted from FIG. 5 to avoid obscuring the drawing.

In the illustrated example, the first PMU 201 operates as a shared power management circuit for the first UHB PAiD module 221, the second UHB PAiD module 222, the third UHB PAiD module 223, and the fourth UHB PAiD module 224. The first PMU 201 can be used, for example, to control a power supply voltage level of the UHB PAiD modules' power amplifiers. Additionally, the first PMU 201 is also shared with the HB PAiD module 225, which transmits and receives HB signals on the first primary antenna 121 and the second primary antenna 122, and with the UL CA and MIMO module 228 used for enhancing MIMO order and a maximum number of supported carriers for carrier aggregation. Thus, the first PMU 201 provides a shared power supply voltage to the UHB PAiD modules 221-224, the HB PAiD module 225, and the UL CA and MIMO module 228, in this example.

By sharing the first PMU 201 in this manner, a common power management scheme, such as fixed supply wide bandwidth average power tracking (APT), can be advantageously used for the modules.

In the illustrated example, the second PMU 202 generates a shared power supply voltage used by the MB PAiD 226 and by the LB PAiD module 227.

In certain implementations, the diversity modules and diversity antennas can be located at relatively far physical distance from the RFIC 203, and connected to the RFIC 203 via cross-UE cables 271-277. Thus, the UHB PAiD modules 221-224 can be placed in remote locations around the UE phone board.

In certain examples herein, a PMU is shared between at least one UHB module and at least one an HB module or an MB module.

The illustrated RF system 200 of FIG. 5 advantageously includes four transmit capable UHB PAiD modules 221-224 coupled to four separate antennas 121-124, respectively, and thus both transmit and receive are equally available at each antenna for UHB communications.

Accordingly, antenna swap can be accomplished without a swap switch to redirect a trace or route. For example, antenna selection can be achieved by controlling which UHB power amplifier(s) of the UHB PAiD modules 221-224 are enabled. Similarly, with respect to receive, the antenna selection can be made by controlling which UHB low noise amplifier(s) of the UHB PAiD modules 221-224 are turned on. Thus, in this example, antenna swap functionality is achieved without using any antenna swap switch.

In certain implementations, the RFIC of FIG. 5 can provide beam steering and/or different data streams through digital baseband control of a relative phase difference between signals provided to the UHB PAiD modules 221-224.

In the illustrated example, the first primary antenna diplexer 204 operates to diplex between UHB frequencies and MB/HB frequencies. Additionally, the second primary antenna diplexer 205 operates to diplex between MB/HB/UHB frequencies and LB frequencies. Furthermore, the first diversity antenna triplexer 206 operates to triplex between UHB frequencies, MB/HB frequencies, and 2 GHz/5 GHz Wi-Fi frequencies. Additionally, the second diversity antenna triplexer 207 operates to triplex between UHB frequencies, LB/HB/MB frequencies, and 2 GHz/5 GHz Wi-Fi frequencies. For clarity of the figures, Wi-Fi modules connected to the first diversity antenna triplexer 206 and to the second diversity antenna triplexer 207 are not illustrated.

With continuing reference to FIG. 5, the first HB/MB diplexer 208 operates to diplex between a first group of HB frequencies (for example, Band 30 and/or Band 40) and MB frequencies. Additionally, the second HB/MB diplexer 209 operates to diplex between a second group of HB frequencies (for example, Band 7 and/or Band 41) and MB frequencies. Furthermore, the MIMO/UHB diplexer 210 operates to diplex between MB/HB frequencies and UHB frequencies. Additionally, the diversity diplexer 211 operates to diplex between MB/HB frequencies and LB frequencies.

In the illustrated example, the RFIC 203 includes a first RX UHB terminal 241, a first TX UHB terminal 242, a first RX HB terminal 243, a second RX HB terminal 244, a TX HB terminal 245, a first RX MB terminal 246, a second RX MB terminal 247, a first TX MB terminal 248, a 2G TX MB terminal 249, a 2G RX MB terminal 250, a first RX LB terminal 251, a second RX LB terminal 252, a TX LB terminal 253, a second TX MB terminal 254, a third RX MB terminal 255, a fourth RX MB terminal 256, a third RX HB terminal 257, a fourth RX HB terminal 258, a second RX UHB terminal 259, a second TX UHB terminal 260, a third TX UHB terminal 261, a fourth TX UHB terminal 262, a first shared RX UHB/HB terminal 263, a second shared RX UHB/HB terminal 264, a first shared RX MB/HB terminal 265, a second shared RX MB/HB terminal 266, and an LB RX terminal 267. As shown in FIG. 5, certain terminals are shared across multiple bands to share resources and/or reduce signal routes (for instance, to use fewer cross-UE cables).

Although one example of a RF system 200 is shown in FIG. 5, the teachings herein are applicable to RF systems implemented in a wide variety of ways.

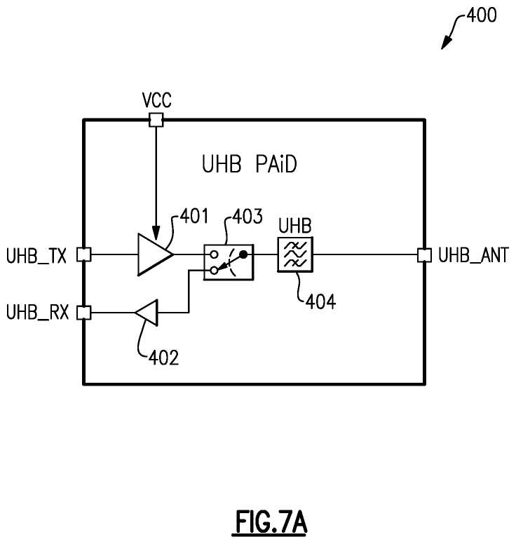

FIG. 6 is a schematic diagram of a RF system 280 according to another example. The RF system 280 includes a first primary antenna 121, a second primary antenna 122, a first diversity antenna 123, a second diversity antenna 124, a first PMU 201, a second PMU 202, an RFIC 203, a primary antenna diplexer 204, a primary antenna triplexer 281, a first diversity antenna triplexer 206, a second diversity antenna triplexer 207, a first HB/MB diplexer 208, a second HB/MB diplexer 209, a diversity diplexer 211, a multi-throw switch 212, a HB TDD filter 213, a first UHB PAiD module 221, a second UHB PAiD module 222, a third UHB PAiD module 223, a fourth UHB PAiD module 224, an HB PAiD module 225, a MB PAiD module 226, an LB PAiD module 227, an UL CA and MIMO module 228, a MB/HB MIMO DRx module 229, a UHB/MB/HB DRx module 230, an LB DRx module 231, a 2G PAM 232, and first to seventh cross-UE cables 271-277, respectively.

The RF system 280 of FIG. 6 is similar to the RF system 200 of FIG. 5, except that the RF system 280 of FIG. 6 includes the primary antenna triplexer 281 rather than the second primary antenna diplexer 205, and omits the MIMO/UHB diplexer 210 in favor of connecting the second UHB PAiD module 222 to the second primary antenna 122 by way of the primary antenna triplexer 281.

Implementing the RF system 280 in this manner connects the second UHB PAiD module 222 to the second primary antenna 122 with lower loss relative to the example of FIG. 5. Thus, the RF system 280 of FIG. 6 has lower insertion loss for certain UHB signal paths, which can enhance the performance of certain CA combinations and/or when operating using UHB MIMO communications.

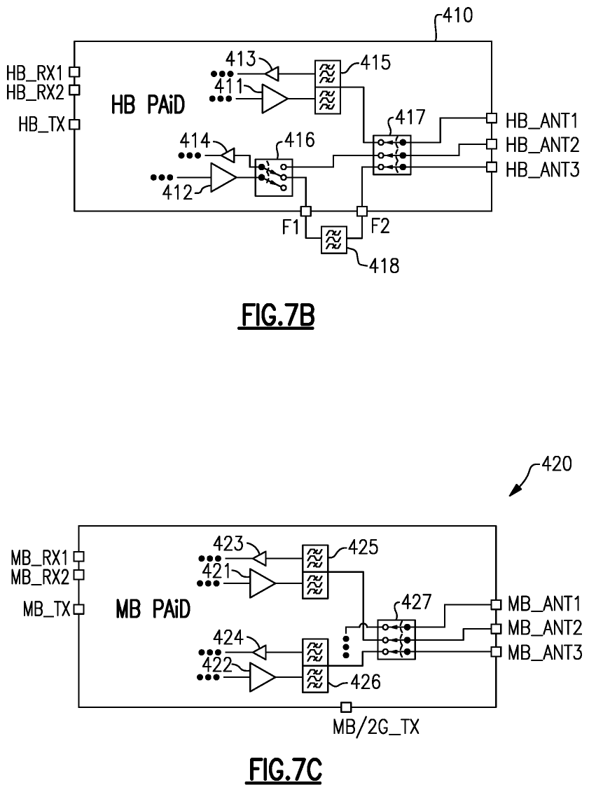

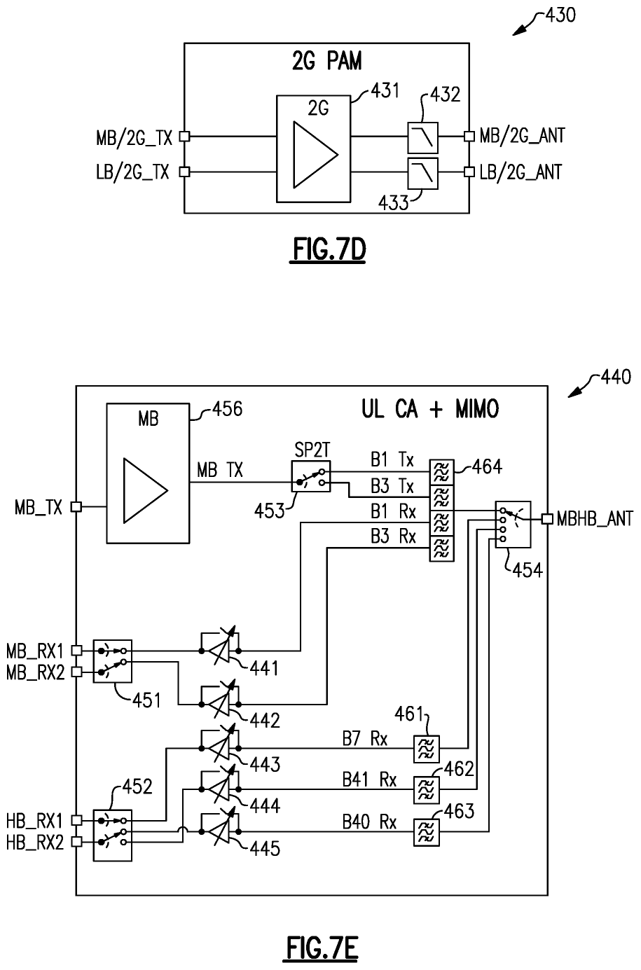

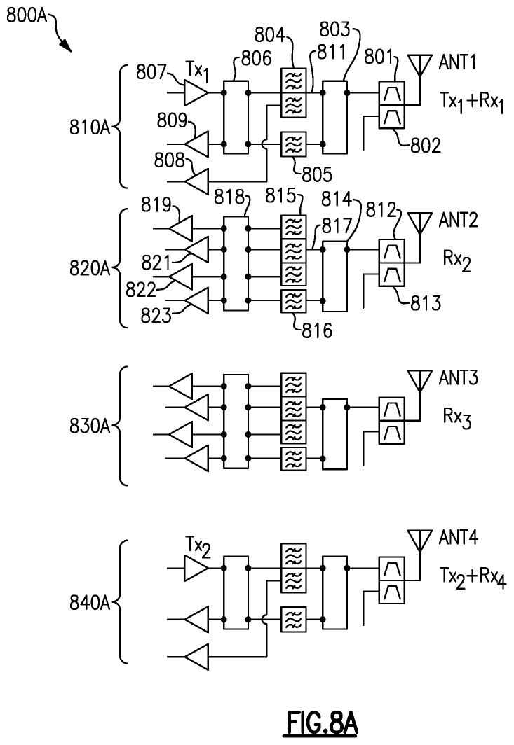

FIG. 7A is a schematic diagram of a UHB transmit and receive module 400 according to one example. The UHB transmit and receive module 400 operates to generate a UHB signal for transmission and to process a UHB signal received from an antenna.

The UHB transmit and receive module 400 illustrates one implementation of a UHB module suitable for incorporation in a RF system, such as any of the RF systems of FIGS. 4A-6. Although the UHB transmit and receive module 400 illustrates one implementation of a UHB module, the teachings herein are applicable to RF electronics including UHB modules implemented in a wide variety of ways. Accordingly, other implementations of UHB modules are possible, such as UHB modules with more or fewer pins, different pins, more or fewer components, and/or a different arrangement of components.

The UHB transmit and receive module 400 includes a power amplifier 401, a low noise amplifier 402, a transmit/receive switch 403, and a UHB filter 404, which is used to pass one or more UHB bands, for instance, Band 42, Band 43, and/or Band 48. The UHB transmit and receive module 400 further includes a variety of pins, including a UHB_TX pin for receiving a UHB transmit signal for transmission, a UHB_RX pin for outputting a UHB receive signal, a UHB_ANT pin for connecting to an antenna, and a VCC pin for receiving a supply voltage for powering at least the power amplifier 401. In certain implementations, the VCC pin receives a shared supply voltage from a power management circuit (for example, a PMU) shared by multiple modules.

The illustrated UHB transmit and receive module 400 provides both transmit and receive functionality for UHB signals. Thus, when four instantiations of the UHB transmit and receive module 400 are coupled directly or indirectly to four antennas, both 4×4 RX MIMO for UHB and 4×4 TX MIMO for UHB can be achieved. Additionally, the UHB transmit and receive modules can be used to support carrier aggregation for UL and/or DL using one or more UHB carrier frequencies.

FIG. 7B is a schematic diagram of a HB transmit and receive module 410 according to one example.

The RF systems disclosed herein can include one or more implementations of the HB transmit and receive module 410. Although the HB transmit and receive module 410 illustrates one implementation of a HB module, the teachings herein are applicable to RF electronics including HB modules implemented in a wide variety of ways as well as to RF electronics implemented without HB modules.

The HB transmit and receive module 410 includes a first power amplifier 411 for FDD communications, a second power amplifier 412 for TDD communications, a first low noise amplifier 413 for FDD communications, a second low noise amplifier 414 for TDD communications, a FDD duplexer 415, a transmit/receive switch 416, and a multi-throw switch 417. An external TDD filter 418 is also included in this example. In another example, the TDD filter 418 is included within the module 410.

The HB transmit and receive module 410 further includes a variety of pins, including a HB_TX pin for receiving a HB transmit signal for transmission, a HB_RX1 pin for outputting a first HB receive signal, a HB_RX2 pin for outputting a second HB receive signal, a F1 pin for connecting to one terminal of the external TDD filter 418, and a F2 pin for connecting to another terminal of the external TDD filter 418. The module 410 further includes a HB_ANT1 pin, a HB_ANT2 pin, and a HB_ANT3 pin for connecting to one or more antennas.

FIG. 7C is a schematic diagram of a MB transmit and receive module 420 according to one example.

The RF systems disclosed herein can include one or more implementations of the MB transmit and receive module 420. Although the MB transmit and receive module 420 illustrates one implementation of a MB module, the teachings herein are applicable to RF electronics including MB modules implemented in a wide variety of ways as well as to RF electronics implemented without MB modules.

The MB transmit and receive module 420 includes a first power amplifier 421, a second power amplifier 422, a first low noise amplifier 423, a second low noise amplifier 424, a first duplexer 425, a second duplexer 426, and a multi-throw switch 427. In certain implementations, the first duplexer 425 and the second duplexer 426 provide duplexing to different MB frequency bands. In one example, the first duplexer 425 is operable to duplex Band 3, while the second duplexer 426 is operable to duplex at least one of (or both of) Band 1 and Band 66.

The MB transmit and receive module 420 further includes a variety of pins, including a MB_TX pin for receiving an MB transmit signal for transmission, a MB_RX1 pin for outputting a first MB receive signal, an MB_RX2 pin for outputting a second MB receive signal, and an MB/2G_TX pin for receiving a 2G transmit signal for transmission. The module 420 further includes an MB_ANT1 pin, an MB_ANT2 pin, and an MB_ANT3 pin for connecting to one or more antennas.

FIG. 7D is a schematic diagram of a 2G power amplifier module (PAM) 430 according to one example.

The RF systems disclosed herein can include one or more instantiations of the 2G PAM 430. Although the 2G PAM 430 illustrates one implementation of a 2G module, the teachings herein are applicable to RF electronics including 2G modules implemented in a wide variety of ways as well as to RF electronics implemented without 2G modules.

The 2G PAM 430 includes power amplifier circuitry 431, an MB 2G filter 432, and an LB 2G filter 433. The 2G PAM 430 further includes a variety of pins, including a MB/2G_TX pin for receiving a 2G MB transmit signal for transmission and an LB/2G_TX pin for receiving a 2G LB transmit signal for transmission. The module 430 further includes an MB/2G_ANT pin and an LB/2G_ANT pin for connecting to one or more antennas.

FIG. 7E is a schematic diagram of an uplink carrier aggregation and MIMO (UL CA+MIMO) module 440 according to one embodiment.

The RF systems disclosed herein can include one or more instantiations of the UL CA+MIMO module 440. Although the UL CA+MIMO module 440 illustrates one implementation of a CA/MIMO module, the teachings herein are applicable to RF electronics including CA/MIMO modules implemented in a wide variety of ways as well as to RF electronics implemented without CA/MIMO modules.

The UL CA+MIMO module 440 includes MB power amplifier circuitry 456, a MB transmit selection switch 453, an MB quadplexer 464, a multi-throw switch 454, a first HB receive filter 461, a second HB receive filter 462, a third HB receive filter 463, an MB receive selection switch 451, an HB receive selection switch 452, a first HB low noise amplifier 441 (with bypass and gain control functionality, in this embodiment), a second HB low noise amplifier 442, a third HB low noise amplifier 443, a fourth HB low noise amplifier 444, and a fifth HB low noise amplifier 445. The UL CA+MIMO module 440 is annotated to show example frequency bands for operation, including Band 1 and Band 3 for MB and Band 7, Band 40, and Band 41 for HB. However, the UL CA+MIMO module 440 can be implemented to operate with other MB frequency bands and/or HB frequency bands.

The UL CA+MIMO module 440 further includes a variety of pins, including an MB_TX pin for receiving an MB transmit signal for transmission, an MB_RX1 pin for outputting a first MB receive signal, an MB_RX2 pin for outputting a second MB receive signal, an HB_RX1 pin for outputting a first HB receive signal, an HB_RX2 pin for outputting a second HB receive signal, and an MBHB_ANT pin for connecting to an antenna.

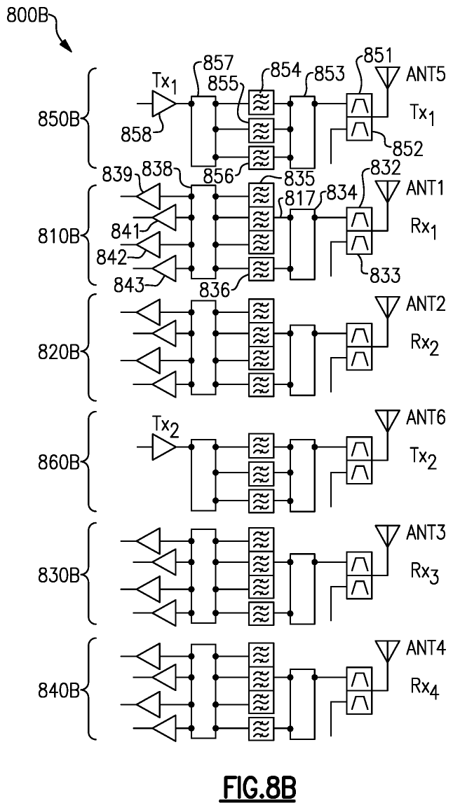

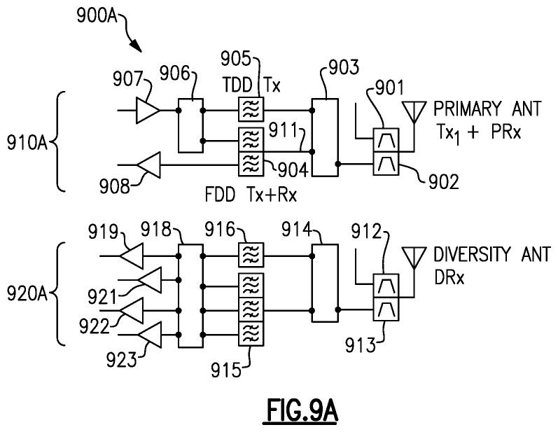

FIG. 8A is a schematic diagram of a radio frequency front end system 800A having four antenna paths 810A, 820A, 830A, 840A that support six total transmit and receive paths Tx1, Tx2, Rx1, Rx2, Rx3, Rx4 because the first antenna path 810A and the fourth antenna path 840A are configured to jointly support duplex transmit and receive capability. In particular, the duplex first antenna path 810A can jointly support both the first transmit path Tx1 and the first receive path Rx1 over ANT1, the simplex second antenna path 820A can support the second receive-only path Rx2 over ANT2, the simplex third antenna path 830A can support the third receive-only path Rx3 over ANT3, and the duplex fourth antenna path 840A can jointly support both the second transmit path Tx2 and the second receive path Rx4 over ANT4.

In the illustrated embodiment, the first antenna path 810A provides both transmit and receive functionality, including frequency division duplex (FDD) transmit/receive. The first antenna path 810A includes a first antenna ANT1 connected to an antenna diplexer. The diplexer includes a first portion 801 having a first frequency passband and a second portion 802 having a second frequency passband. The first and second portions 801, 802 connect on a simplex side to the antenna ANT1. The first portion 801 is connected on a multiplexed side of the diplexer to a switch 803. The second portion 802 is connected on the multiplexed side of the diplexer to another communication path, which is not shown. The switch 803 is configured to be controlled (e.g., by a controller of a front end module) to selectively connect the first portion 801 of the diplexer to either a duplexer 804 or a filter 805. In some embodiments and modes of operation, the switch can optionally simultaneously connect the first portion 801 of the diplexer to both the duplexer 804 and the filter 805. The controller of the front end module can respond to commands received by a baseband processor, transceiver, or other appropriate component of a mobile device on which the front end system resides, for example, to control the switch 803.

The duplexer 804 can be configured for concurrent reception and transmission (e.g., during frequency division duplex operation) and include a transmit filter and a receive filter. As shown, the transmit filter of the duplexer 804 is connected to via a switch 806 to an output of a transmit amplifier 807, such as a power amplifier. The receive filter of the duplexer 804 is connected to a receive amplifier 808, such as a low noise amplifier. In this manner, the duplexer can allow for FDD communication in which data output by the power amplifier 807 is transmitted via the path 810A to the antenna ANT1 concurrently with data being received by the ANT1 being communicated via the path 810A to the receive amplifier 808.

The filter 805 is connected to the switch 806, which can selectively connect the filter 805 to the receive amplifier 809 or to the transmit amplifier 807, depending on the embodiment and the mode of operation (e.g., TDD Tx or TDD Rx).

As shown, on the antenna side of the duplexer 804, the transmit and receive filters can have a common merged connection 811. This common merged connection can be referred to as a “ganged” connection, and the transmit and receive filters can be referred to as having been “ganged” together. The transmit and receive filters can also be considered direct connected, in contrast, for example, to being connected via some intermediate component such as a multiplexer or switch. In some embodiments, the transmit and receive filter are included in a common package, for example, which includes a port corresponding to the merged connection. For example, the transmit and receive filters of the duplexer 804 can be acoustic wave filters in a common package and each including one or more surface acoustic wave (SAW) or bulk acoustic wave (BAW) resonators. In other embodiments, the transmit and receive filters are included in separate packages and the merged connection is formed on a module substrate or other appropriate location.

Some or all of the transmit filter of the duplexer 804, the receive filter of the duplexer 804, and/or the filter 805 can have different passbands, thereby allowing for FDD or TDD communication over multiple bands.

The second path 820A provides for receive functionality over a second antenna ANT2, which is connected to a diplexer having first and second portions 812, 813. The diplexer can operate similar to or the same as the diplexer of the first path 810A. The first portion 812 of the diplexer selectively connected via the switch 814 to either the triplexer filter 815 or the filter 816. In some embodiments and modes of operation, the switch 814 can optionally connect the first portion 812 of the diplexer to both the triplexer 815 and the filter 816 concurrently. The triplexer 815 has a group of three receive filters including a common connection 817 The three filters of the triplexer 815 can be included in a common package, or separate packages, depending on the embodiment. Each filter of the triplexer 815 can have a different frequency passband, thereby allowing for reception of three different receive bands detected by the antenna ANT2.

The three filters of the triplexer 815 and the filter 816 are selectively connected via a switch 818 to four receive amplifiers 819, 821, 822, 823. For example, according to one embodiment, the switch 818 can connect any of the four receive amplifiers 819, 121, 822, 823 to any of three filters of the triplexer 815 or the filter 816. Some or all of the three filters of the triplexer 815 and the filter 816 can have different passbands, thereby allowing for communication using the second path 820A on multiple (e.g., at least four) communication bands for simultaneous or serial reception, depending on the embodiment and/or operating mode. In another embodiment, the switch 818 connects each filter to one dedicated corresponding amplifier of the four receive amplifiers 819, 821, 822, 823. Thus, the second path 820A in some embodiments provides reception on up to four receive paths, some or all of which can have different frequency ranges.

The third path 830A is similar to the second path 820A but is connected to a third antenna ANT3 and can similarly allow for simplex radio frequency reception on up to four different receive channels.

The fourth path 840A is similar to the first path 810A but is connected to a fourth antenna ANT4 and allows for duplex transmit and receive functionality, including FDD communication.

Referring again to the first path 810A, the merged, direct connection 811 of the transmit filter and the receive filter of the duplexer 804 can help improve isolation between the transmit and receive paths during concurrent FDD transmit/receive as compared to an implementation where the transmit and receive filters are not co-designed and are separately connected to the switch 803, for example, without a merged connection. However, the merged, ganged together configuration loads the transmit filter with the receive filter and vice versa, resulting in higher insertion loss for the FDD transmit and receive paths, and can cause reduced FDD performance. In addition, where the first path 810A is configured for TDD operation (via the filter 805) concurrently with FDD operation (via the duplexer 804), the TDD path can suffer performance reduction when the TDD receive path is active and impacted by the FDD transmit carrier leakage and/or receive band noise.

FIG. 8B is a schematic diagram of the exemplary front end system 800B that overcomes such challenges by separating the duplex paths into independent simplex paths without including merged, directly connected transmit and receive filters, in contrast to the system of FIG. 8A. Like the system 800A, the system 800B of FIG. 8B includes the six transmit and receive paths Tx1, Tx2, Rx1, Rx3, Rx4. However, in the system 800B each path is in a simplex configuration having separate Tx and Rx filters, with separate traces to six separate antennas ANT1-ANT6 over six separate simplex antenna paths 810B-860B. In the illustrated embodiment, none of said paths may be configured for concurrent or duplex reception and transmission. Rather, each of the paths 810B-860B may be configured as simplex paths for either reception or transmission.

The first path 810B provides for simplex receive-only functionality over a first antenna ANT1, which is connected to a diplexer having first and second portions 832, 833. The first path 810B can be similar to or the same as the simplex receive paths 820A, 830A of the front end system 800A of FIG. 8A, for example. The first portion 832 of the diplexer selectively connected via the switch 834 to either the triplexer filter 835 or the filter 836. In some embodiments and modes of operation, the switch 834 can optionally connect the first portion 832 of the diplexer to both the triplexer 835 and the filter 836 concurrently. The triplexer 835 has a group of three receive filters including a common connection 817. The three filters of the triplexer 835 can be included in a common package, or separate packages, depending on the embodiment. Each filter of the triplexer 815 can have a different frequency passband, thereby allowing for reception of three different receive bands detected by the antenna ANT2.

The three filters of the triplexer 835 and the filter 836 are selectively connected via a switch 838 to four receive amplifiers 839, 841, 842, 843. For example, according to one embodiment, the switch 838 can connect any of the four receive amplifiers 839, 841, 842, 843 to any of three filters of the triplexer 835 or the filter 836. Some or all of the three filters of the triplexer 835 and the filter 836 can have different passbands, thereby allowing for communication using the first path 810B on multiple communication bands for simultaneous or serial communication, depending on the embodiment and/or operating mode. In another embodiment, the switch 838 connects each filter to one dedicated corresponding amplifier of the four receive amplifiers 839, 841, 842, 843. Thus, the first path 810B provides reception on up to four receive paths, some or all of which can have different frequency ranges.

The second antenna path 820B, third antenna path 830B, and fourth antenna path 840B similarly support simplex receive-only capability for respective receive paths Rx2, Rx3, Rx4 over the respective antennas ANT2, ANT3, ANT4. As shown, in the illustrated embodiment the paths 820B, 830B, 840B are similar to the first antenna path 810B in structure and function, but, depending on the embodiment, some or all of the receive paths 810B, 820B, 830B, 840B can be configured to support different communication bands, e.g., depending on the passbands of the filters, amplifiers, and other appropriate components in the respective paths 810B, 820B, 830B, 840B.

The fifth antenna path 850B, on the other hand, is configured for simplex transmit-only functionality, supporting transmit path Tx1 over a fifth antenna ANT5. The diplexer includes a first portion 851 having a first frequency passband and a second portion 852 having a second frequency passband. The first and second portions 851, 852 connect on a simplex side to the antenna ANT5. The first portion 851 is connected on a multiplexed side of the diplexer to a switch 853. The second portion 852 is connected on the multiplexed side of the diplexer to another communication path, which is not shown. The switch 853 is configured to be controlled (e.g., by a controller of a front end module) to selectively connect the first portion 851 to one of the transmit filters 854, 855, 856. In some embodiments and modes of operation, the switch 853 can optionally simultaneously connect the first portion 851 of the diplexer to more than one of the transmit filters 854, 855, 856, thereby allowing simultaneous transmit over multiple bands.

The three transmit filters 854, 855, 856 can be in separate packages as shown, or included in a common package. The transmit filters 854, 855, 856 are not direct connected to one another with a merged connection, unlike the duplexer 804 of the system 800A of FIG. 8A. In some embodiments, one or more of the filters 854, 855, 856 can be included in the same package but without a merged or ganged connection to one another, thereby reducing loading and insertion loss. For example, transmit filters 854, 855, 856 can be acoustic wave filters in separate or common packaging, each including one or more surface acoustic wave (SAW) or bulk acoustic wave (BAW) resonators.

The transmit filters 854, 855, 856 are connected to a switch 857, which is configured to selectively connect the transmit power amplifier 858 to one of the filters 854, 855, 856, e.g., depending on the currently active transmit band. For example, the transmit amplifier 858 can be configured to operate over a wide enough range of frequencies to support at least three separate bands corresponding to passbands of the three filters 854, 855, 856. In other embodiments, more than one amplifier can be used and selectively connected to the filters 854, 855, 856.

Like the fifth path 850B, the sixth path 860B similarly supports simplex transmit-only capability for the second transmit path over the sixth antenna ANT6, but for the transmit path Tx2.

As compared to the front end system 800A of FIG. 8A, the front end system 800B of FIG. 8B includes two additional antennas ANT5, ANT6. Unlike the system 800A of FIG. 8A, the system 800B splits Tx1, Rx1, which shared a single antenna ANT1 in FIG. 8A, into separate the simplex transmit-only and receive-only paths Tx1, Rx1 over two antennas ANT5, ANT1. The system 800B similarly splits the shared duplex Tx2+Rx4 path 840A of the system 800A of FIG. 8A, which shared a single antenna ANT4, into separate the simplex transmit-only and receive only paths Tx2, Rx4 over two antennas ANT6, ANT2. By creating separate simplex antenna paths, the system 800B of FIG. 8B leverages strong antenna isolation, e.g. the antenna isolation between Tx₁ (ANT5) and Rx₁ (ANT1), and Tx₂ (ANT6) and Rx₄ (ANT2). This improves power capability, Tx DC Efficiency, Rx Sensitivity, IMD, and MSD as compared to the system 800A of FIG. 8A, which, as described previously, can suffer from filter loading and insertion loss due to the merged duplexer Tx/Rx connections, and from transmit leakage into the receive channels within the duplexed paths 810A, 840A.

While the illustrated embodiment shows one possible implementation, a variety of alternative embodiments are possible. For example, the switches of the antenna paths 810B-860B coupled between the respective diplexers and filters of the antenna paths (e.g., the filters 853, 834 of antenna paths 810B, 850B) are shown to be in separate packages, such that there are six separate switch packages in FIG. 8B, one for each antenna path 810B-860B. In other embodiments, one or more of these switches may consolidated into common packaging. For example, 2, 3, 4, 5, or all 6 of the switches may be consolidated into a common packaging, depending on the embodiment.

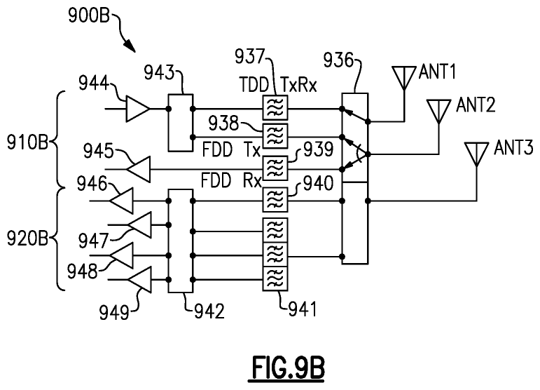

FIG. 9A is a schematic diagram of an example of a front end system 900A including a first antenna path 910A corresponding to a primary antenna (PRIMARY ANT) and a second antenna path 920A corresponding to diversity antenna (DIVERSITY ANT). For example, some or all of the first antenna path 910A may reside in a primary front end module providing a primary communication path for a mobile device. The first antenna path 910A can support the transmit path Tx1 and a primary receive PRx path for the mobile device. Some or all of the second antenna path 920A may reside in a diversity receive module configured to support a diversity receive path DRx providing supplemental downlink bandwidth and/or reliability. The primary front end module and the diversity receive front end module can be in separate module packages, depending on the embodiment. For example, in some embodiments, all of the componentry of the first antenna path 910A except the primary antenna is included in the primary front end module and all of the componentry of the second antenna path 920A except the diversity antenna is included in the diversity receive front end module.

The first antenna path 910A of said plurality of paths may be configured for duplex, e.g., concurrent reception (Rx) and transmission (Tx), whereas the second antenna path 920A is configured as a simplex receive-only path.

In the illustrated embodiment, the first antenna path 910A provides both transmit and receive functionality, including frequency division duplex (FDD) transmit/receive.

The primary antenna is connected to an antenna diplexer including a first portion 901 having a first frequency passband and a second portion 902 having a second frequency passband. The first and second portions 901, 902 connect on a simplex side to the primary antenna. The second portion 902 is connected on a multiplexed side of the diplexer to a switch 903. The first portion 901 is connected on the multiplexed side of the diplexer to another communication path, which is not shown. The switch 903 is configured to be controlled (e.g., by a controller of a front end module) to selectively connect the first portion 902 of the diplexer to either a duplexer 904 or a filter 905. In some embodiments and modes of operation, the switch can optionally simultaneously connect the second portion 902 of the diplexer to both the duplexer 904 and the filter 904.

The duplexer 904 can be configured for concurrent reception and transmission (e.g., during frequency division duplex operation) and include a transmit filter and a receive filter. As shown, the transmit filter of the duplexer 904 is connected to via a switch 906 to an output of a transmit amplifier 907, such as a power amplifier. The receive filter of the duplexer 904 is connected to a receive amplifier 908, such as a low noise amplifier. In this manner, the duplexer can allow for FDD communication in which data output by the power amplifier 907 is transmitted via the path 910A to the primary antenna concurrently with data being received by the primary antenna being communicated via the path 910A to the receive amplifier 908.

The filter 905 is connected to the switch 906, which can selectively connect the output of the filter 905 to the transmit amplifier 907, depending on the embodiment and the mode of operation. For example, in a TDD transmit mode a controller of the front end system 900A can cause the switch 906 to connect the output of the power amplifier 907 to the filter 905, and cause the switch 903 to connect the output of the filter 905 to the second portion of the diplexer 902. In contrast, in an FDD Tx+Rx mode, the controller can cause the switch to connect the output of the power amplifier 907 to the transmit filter of the duplexer 904, and cause the switch 903 to connect the merged output 911 of output of the duplexer 904 to the second portion of the diplexer 902.

As shown, on the antenna side of the duplexer 904, the transmit and receive filters can have a common merged connection 911. This common merged connection can be referred to as a “ganged” connection, and the transmit and receive filters can be referred to as having been “ganged” together. The transmit and receive filters can also be considered direct connected, in contrast, for example, to being connected via some intermediate component such as a multiplexer or switch. In some embodiments, the duplexers are included in a common package, for example, which includes a port corresponding to the merged connection. For example, the transmit and receive filters of the duplexer 804 can be acoustic wave filters in a common package and each including one or more surface acoustic wave (SAW) or bulk acoustic wave (BAW) resonators. In other embodiments, the transmit and receive filters are included in separate packages and the merged connection is formed on a module substrate or other appropriate location.

Some or all the transmit filter of the duplexer 904, the receive filter of the duplexer 904, and/or the filter 905 can have different passbands, thereby allowing for FDD or TDD communication over multiple bands.

Referring again to the first path 910A, the merged, direct connection 911 of the transmit filter and the receive filter of the duplexer 904 can help improve isolation between the transmit and receive paths during concurrent FDD transmit/receive as compared to an implementation where the transmit and receive filters are not co-designed and are separately connected to the switch 803, for example, without a merged connection. However, the merged, ganged together configuration loads the transmit filter with the receive filter and vice versa, resulting in higher insertion loss for the FDD transmit and receive paths, and can cause reduced FDD performance.

The second path 920A includes a diplexer including a first portion 912 and a second portion 913, a switch 914, a triplexer 915, a filter 916, a switch 918, and receive amplifiers 919, 921, 922, 923. The second path 910B can function in generally a similar way to the receive paths 820B, 830B, 840B of the system 800B of FIG. 8B, for example.

FIG. 9B illustrates a front end system 900B including a first path 910B and a second path 920B. Like the front end system 900A of FIG. 9A, the system 900B is capable of FDD operation over the path 910B. However, unlike the implementation of FIG. 9A, the system 900B does not include a duplexer with a merged connection. Instead, the system 900B includes a transmit filter 938 and a receive filter 939 that can be used for FDD operation but have been separated and are not ganged together or otherwise directly connected. Moreover, unlike the system 900A, the system 900B includes three antennas ANT1, ANT2, ANT3 instead of one primary antenna and one diversity antenna, allowing for the FDD transmit and FDD receive paths to be connected to different antennas, thereby leveraging antenna isolation and allowing for relaxed filter design, and/or improved performance.

The three antennas ANT1, ANT2, ANT3 are connected via a switch 936 to the filters, which include a first transmit filter 937, a second transmit filter 938, a first receive filter 939, a second receive filter 940, and a triplexer 941

Depending on the embodiment, the switch 936 can connect any of the antennas ANT1, ANT2, ANT3 to any of the filters. Moreover, the switch 936 can be configured to simultaneously connect both the second transmit filter 938 and the first receive filter 939 to one of the antennas ANT1, ANT2, ANT3, allowing for optional FDD operation over a single antenna, but where the transmit and receive filters 938, 949 are indirectly connected via the intermediate switch 936. In such an operating mode, the switch 936 can provide some isolation between the transmit and receive paths at the filters, relaxing the filtering requirements. The switch 936 can additionally or alternatively be configured to allow for FDD operation over multiple antennas by connecting the second transmit filter 938 and the first receive filter 939 to two different antennas, thereby allowing for FDD operation over separate antennas, benefiting from the substantial antenna-to-antenna isolation between the FDD transmit and receive paths.

Generally, the system 900B can allow for transmission Tx on any one of the antennas at a given time, primary receive PRx on a second antenna, and diversity receive DRx on the third antenna. While not illustrated in FIG. 9B, in other embodiments an additional antenna, transmit amplifier, switches, and/or filters can be added to support an additional transmit path Tx2 and Tx1, Tx2 transmission on separate antennas for higher transmit power and lower intermodulation distortion (IMD), such as for EN-DC implementations.

In this fashion, the embodiment in FIG. 9B provides a co-integration of Tx and Rx filters and paths. The switch 936 is thus configured to either 1) switch-combine the Tx and Rx filters 938, 939 together in a conventional FDD configuration, or 2) keep the paths separate to separate antennas for FDD receive and transmit on separate antennas. While certain embodiments have been illustrated, various configurations are possible, such as those including four antennas for MHB support, or those including six or more antennas

It should be appreciated that the terms “simplex” and “duplex” as used in conjunction with the antenna paths, e.g., the paths 810A-840A of FIG. 8A, 810B-860B of FIG. 8B, 910A-920A of FIG. 9A, and 910B-920B of FIG. 9B are generally used herein to indicate whether the respective antenna paths are capable of only receiving data (simplex), only transmitting data (simplex), or both transmitting and receiving data (duplex). For example, the antenna path 820A of FIG. 8A is a simplex path in the sense that it can only receive and not transmit data, even though there are multiple receive paths/channels within the antenna path 820A.

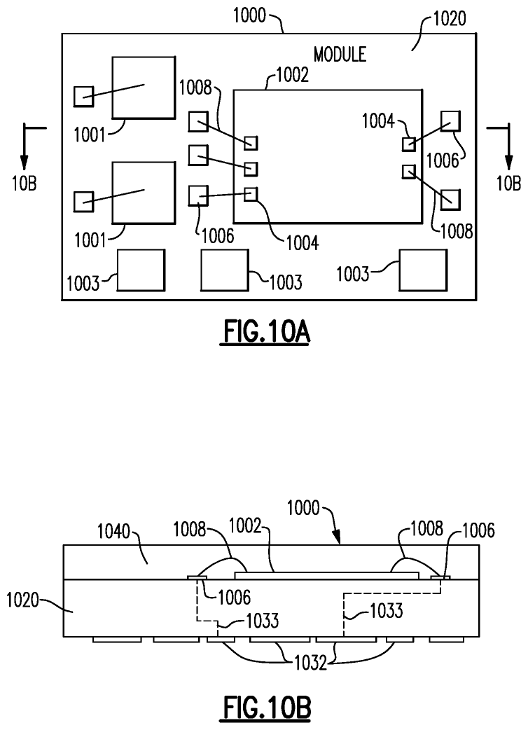

FIG. 10A is a schematic diagram of one embodiment of a packaged module 1000. FIG. 10B is a schematic diagram of a cross-section of the packaged module 1000 of FIG. 10A taken along the lines 10B-10B. The module 1000 can include one or more of the front end systems described herein, such as any of the front end systems 800A, 800B, 900A, or 900B of FIGS. 8A, 8B, 9A, or 9B, respectively, or any portion thereof.

The RFFE systems herein can include one or more packaged modules, such as the packaged module 1000. Although the packaged module 1000 of FIGS. 10A-10B illustrates one example implementation of a module suitable for use in an RFFE system, the teachings herein are applicable to modules implemented in other ways.

The packaged module 1000 includes radio frequency components 1001, a semiconductor die 1002, surface mount devices 1003, wirebonds 1008, a package substrate 1020, and encapsulation structure 1040. The package substrate 1020 includes pads 1006 formed from conductors disposed therein. Additionally, the semiconductor die 1002 includes pins or pads 1004, and the wirebonds 1008 have been used to connect the pads 1004 of the die 1002 to the pads 1006 of the package substrate 1020.

As shown in FIG. 10B, the packaged module 1000 is shown to include a plurality of contact pads 1032 disposed on the side of the packaged module 1000 opposite the side used to mount the semiconductor die 1002. Configuring the packaged module 1000 in this manner can aid in connecting the packaged module 1000 to a circuit board, such as a phone board of a wireless device. The example contact pads 1032 can be configured to provide radio frequency signals, bias signals, and/or power (for example, a power supply voltage and ground) to the semiconductor die 1002. As shown in FIG. 10B, the electrical connections between the contact pads 1032 and the semiconductor die 1002 can be facilitated by connections 1033 through the package substrate 1020. The connections 1033 can represent electrical paths formed through the package substrate 1020, such as connections associated with vias and conductors of a multilayer laminated package substrate.

In some embodiments, the packaged module 1000 can also include one or more packaging structures to, for example, provide protection and/or facilitate handling. Such a packaging structure can include overmold or encapsulation structure 1040 formed over the packaging substrate 1020 and the components and die(s) disposed thereon.

It will be understood that although the packaged module 1000 is described in the context of electrical connections based on wirebonds, one or more features of the present disclosure can also be implemented in other packaging configurations, including, for example, flip-chip configurations.

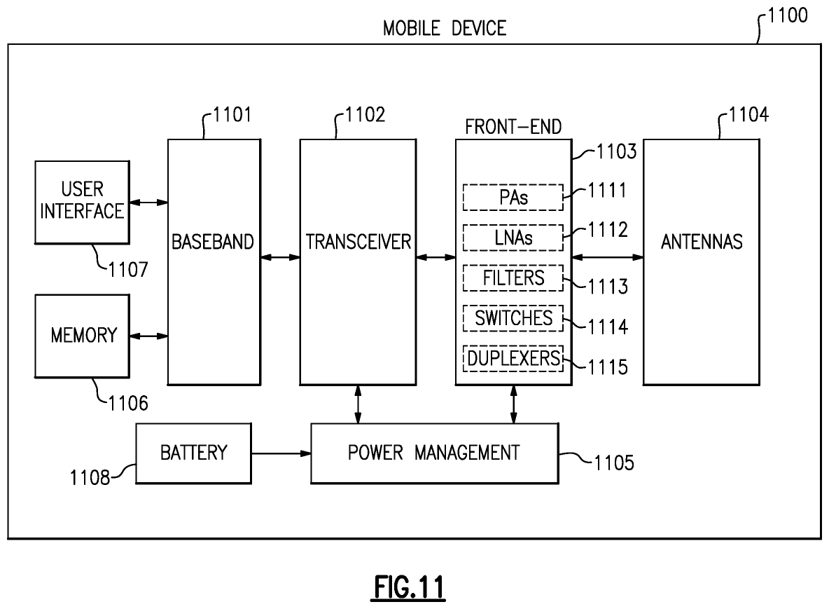

FIG. 11 is a schematic diagram of one embodiment of a mobile device 1100. The mobile device 1100 includes a baseband system 1101, a transceiver 1102, a front-end system 1103, antennas 1104, a power management system 1105, a memory 1106, a user interface 1107, and a battery 1108. The front-end 1103 of the mobile device 1100 can include one or more of the front end systems described herein, such as any of the front end systems 800A, 800B, 900A, or 900B of FIGS. 8A, 8B, 9A, or 9B, respectively, or any portion thereof.

The mobile device 1100 can be used communicate using a wide variety of communications technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), and/or GPS technologies.

The transceiver 1102 generates RF signals for transmission and processes incoming RF signals received from the antennas 1104.

The front-end system 1103 aids in conditioning signals transmitted to and/or received from the antennas 1104. In the illustrated embodiment, the front-end system 1103 includes power amplifiers (PAs) 1111, low noise amplifiers (LNAs) 1112, filters 1113, switches 1114, and duplexers 1115. However, other implementations are possible.

For example, the front-end system 1103 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 1100 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 1104 can include antennas used for a wide variety of types of communications. For example, the antennas 1104 can include antennas for transmitting and/or receiving signals associated with a wide variety of frequencies and communications standards.

In certain implementations, the antennas 1104 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 1100 can operate with beamforming in certain implementations. For example, the front-end system 1103 can include phase shifters having variable phase controlled by the transceiver 1102. Additionally, the phase shifters are controlled to provide beam formation and directivity for transmission and/or reception of signals using the antennas 1104. For example, in the context of signal transmission, the phases of the transmit signals provided to the antennas 1104 are controlled such that radiated signals from the antennas 1104 combine using constructive and destructive interference to generate an aggregate transmit signal exhibiting beam-like qualities with more signal strength propagating in a given direction. In the context of signal reception, the phases are controlled such that more signal energy is received when the signal is arriving to the antennas 1104 from a particular direction. In certain implementations, the antennas 1104 include one or more arrays of antenna elements to enhance beamforming.

The baseband system 1101 is coupled to the user interface 1107 to facilitate processing of various user input and output (I/O), such as voice and data. The baseband system 1101 provides the transceiver 1102 with digital representations of transmit signals, which the transceiver 1102 processes to generate RF signals for transmission. The baseband system 1101 also processes digital representations of received signals provided by the transceiver 1102. As shown in FIG. 11, the baseband system 1101 is coupled to the memory 1106 of facilitate operation of the mobile device 1100.

The memory 1106 can be used for a wide variety of purposes, such as storing data and/or instructions to facilitate the operation of the mobile device 1100 and/or to provide storage of user information.

The power management system 1105 provides a number of power management functions of the mobile device 1100. In certain implementations, the power management system 1105 includes a PA supply control circuit that controls the supply voltages of the power amplifiers 1111. For example, the power management system 1105 can be configured to change the supply voltage(s) provided to one or more of the power amplifiers 1111 to improve efficiency, such as power added efficiency (PAE).

As shown in FIG. 11, the power management system 1105 receives a battery voltage from the battery 1108. The battery 1108 can be any suitable battery for use in the mobile device 1100, including, for example, a lithium-ion battery.

The front-end system 1103 of FIG. 11 can be implemented in accordance with one or more features of the present disclosure. Although the mobile device 1100 illustrates one example of a RF communication device that can include a RFFE system implemented in accordance with the present disclosure, the teachings herein are applicable to a wide variety of RF electronics.

Aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly coupled, or coupled by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively.

While certain embodiments have been described, these embodiments have been presented by way of example only, and are not intended to limit the scope of the disclosure. Indeed, the novel resonators, filters, multiplexer, devices, modules, wireless communication devices, apparatus, methods, and systems described herein may be embodied in a variety of other forms. Furthermore, various omissions, substitutions and changes in the form of the resonators, filters, multiplexer, devices, modules, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope and spirit of the disclosure.

What is claimed is:

1. A radio frequency front end system comprising:
a first transmit path and a first receive path;
a first transmit filter within the first transmit path and a first receive filter within the first receive path; and
one or more switches configured to selectively connect a first antenna to the first transmit filter and to selectively connect a second antenna to the first receive filter to allow frequency division duplex communication over the first transmit path and the first receive path in which the first transmit path transmits over the first antenna simultaneous with the first receive path receiving over the second antenna.

2. The radio frequency front end system of claim 1 further comprising a diversity receive path and a third receive filter within the diversity receive path, the one or more switches further configured to selectively connect a third antenna to the diversity receive path.

3. The radio frequency front end system of claim 1 further comprising a first conductive segment connecting the first transmit filter to a first port of the one or more switches and a second conductive segment connecting the first receive filter to a second port of the one or more switches.

4. The radio frequency front end system of claim 3 wherein the one or more switches are further configured to selectively connect the first antenna to both the first transmit filter and first receive filter to allow frequency division duplex communication over the first transmit path and the first receive path in which the first transmit path transmits over the first antenna simultaneous with the first receive path receiving over the first antenna.

5. The radio frequency front end system of claim 1 further comprising a second transmit path and a second receive path, a second transmit filter within the second transmit path and a second receive filter within the second receive path, the one or more switches configured to selectively connect a third antenna to the second transmit filter and to selectively connect a fourth antenna to the second receive filter to allow frequency division duplex communication over the second transmit path and the second receive path in which the second transmit path transmits over the third antenna simultaneous with the second receive path receiving over the fourth antenna.

6. The radio frequency front end system of claim 1 wherein the first transmit filter and the first receive filter are in separate integrated circuit packages.

7. The radio frequency front end system of claim 1 wherein the first transmit path includes a first transmit power amplifier, the first transmit filter coupled between the first transmit power amplifier and the one or more switches, and the first receive path includes a first receive amplifier, the first receive filter coupled between the one or more switches and the first receive amplifier.

8. The radio frequency front end system of claim 1 further comprising control circuitry configured, in response to one or more commands, cause the one or more switches to selectively connect the first antenna to the first transmit filter and selectively connect the second antenna to the first receive filter.

9. The radio frequency front end system of claim 1 wherein the one or more switches include at least a first switch in a first integrated circuit package and at least a second switch in a second integrated circuit package, the first switch configured to selectively connect the first antenna to the first transmit filter and the second switch configured to selectively connect the second antenna to the first receive filter.

10. A mobile device comprising:
a first antenna and a second antenna; and
a front end system including a first transmit path and a first receive path, a first transmit filter within the first transmit path and a first receive filter within the first receive path, and one or more switches configured to selectively connect the first antenna to the first transmit filter and to selectively connect the second antenna to the first receive filter to allow frequency division duplex communication over the first transmit path and the first receive path in which the first transmit path transmits over the first antenna simultaneous with the first receive path receiving over the second antenna.

11. The mobile device of claim 10 wherein the front end system further includes a diversity receive path and a third receive filter within the diversity receive path, the one or more switches further configured to selectively connect a third antenna to the diversity receive path.

12. The mobile device of claim 10 further comprising a first conductive segment connecting the first transmit filter to a first port of the one or more switches and a second conductive segment connecting the first receive filter to a second port of the one or more switches.

13. The mobile device of claim 12 wherein the one or more switches are further configured to selectively connect the first antenna to both the first transmit filter and first receive filter to allow frequency division duplex communication over the first transmit path and the first receive path in which the first transmit path transmits over the first antenna simultaneous with the first receive path receiving over the first antenna.

14. The mobile device of claim 10 further comprising a second transmit path and a second receive path, a second transmit filter within the second transmit path and a second receive filter within the second receive path, the one or more switches configured to selectively connect a third antenna to the second transmit filter and to selectively connect a fourth antenna to the second receive filter to allow frequency division duplex communication over the second transmit path and the second receive path in which the second transmit path transmits over the third antenna simultaneous with the second receive path receiving over the fourth antenna.

15. The mobile device of claim 10 wherein the first transmit filter and the first receive filter are in separate integrated circuit packages.

16. The mobile device of claim 10 wherein the first transmit path includes a first transmit power amplifier, the first transmit filter coupled between the first transmit power amplifier and the one or more switches, and the first receive path includes a first receive amplifier, the first receive filter coupled between the one or more switches and the first receive amplifier.

17. The mobile device of claim 10 further comprising one or more processors, and the front end system further including control circuitry configured, in response to one or more commands issued by the one or more processors, cause the one or more switches to selectively connect the first antenna to the first transmit filter and selectively connect the second antenna to the first receive filter.

18. A method of operating a radio frequency system comprising:
actuating one or more switches to selectively connect a first antenna to a first transmit filter, the first transmit filter within a first transmit path;
actuating the one or more switches to selectively connect a second antenna to a first receive filter, the first receive filter within a first receive path; and
operating the first transmit path and the first receive path to perform frequency division duplex communication over the first transmit path and the first receive path in which the first transmit path transmits over the first antenna simultaneous with the first receive path receiving over the second antenna.

19. The method of claim 18 further comprising:
actuating the one or more switches to selectively connect the first antenna to both the first transmit filter and the first receive filter; and
operating the first transmit path and the first receive path to perform frequency division duplex communication over the first transmit path and the first receive path in which the first transmit path transmits over the first antenna simultaneous with the first receive path receiving over the first antenna.

20. The method of claim 18 further comprising:
actuating the one or more switches to selectively connect a third antenna to a second transmit filter in a second transmit path;
actuating the one or more switches to selectively connect a fourth antenna to a second receive filter in a second receive path;
performing frequency division duplex communication over the second transmit path and the second receive path in which the second transmit path transmits over the third antenna simultaneous with the second receive path receiving over the fourth antenna.
